(19) United States
(12) Patent Application Publication
(10) Pub. No.: US 2004/0041760 A1
(43) Pub. Date: Mar. 4, 2004

(54) Liquid crystal display

(76) Inventors: Makoto Tsumura, Hitachi (JP); Akitoyo Konno, Hitachi (JP); Tsunenori Yamamoto, Hitachi (JP); Ikuo Hiyama, Hitachinaka (JP)

Correspondence Address: DICKSTEIN SHAPIRO MORIN & OSHINSKY LLP, 2101 L STREET NW, WASHINGTON, DC, 20037-1526, US

(21) Appl. No.: 10/612,995

(22) Filed: Jul. 7, 2003

(30) Foreign Application Priority Data
Aug. 30, 2002 (JP) 2002-252330

(51) Int. Cl. G09G 3/36

(52) U.S. Cl. 345/87

(57) ABSTRACT

A liquid crystal display device includes a periodically switching light source repeatedly turning ON and OFF at a predetermined timing and a display unit for displaying an image by controlling light transmission or reflection of the periodically switching light source according to the image data. In each display frame constituting one image, write into the liquid crystal display device is divided into a first write for writing into all the pixels using precharge data as representative of a plurality of pixels created according to a first algorithm and a second write for additionally writing overwriting data created on at least some pixels according to a second algorithm, thereby displaying an image. In the liquid crystal display device using the periodically switching light source, the periodically switching ghost is suppressed and the moving picture display performance is improved.

### BACKGROUND OF THE INVENTION

The present invention relates to a liquid crystal display device, and in particular to a liquid crystal display device appropriately used for moving picture display in which the moving picture quality is enhanced by usings a periodically switching light source.

A liquid crystal display is widely used as a display unit in the desktop personal computer, notebook personal computer, or a mobile device such as a cellular phone. Recently, for saving space and reducing power consumption, special attention is paid on the liquid crystal television to replace the CRT (Cathode Ray Tube) type television. The liquid crystal display has excellent properties such as thin-width and light-weight, lower power consumption, and high resolution as compared to the CRT display. However, when displaying a moving picture, although the liquid crystal display can exhibit display performance like the CRT display if the moving picture moves at a low speed, the image blurs or the contrast ratio is lowered and the image visibility is often lowered if an object moves rapidly such as in a-sport program.

As the display principle of the liquid crystal display, in addition to the TN (twisted nematic mode) which is used widely, the IPS (in-plane switching mode) having a wide viewing angle, the VS (vertical alignment mode), and the MVA (multi-domain vertical alignment mode) are used. They form an image by applying an illumination light of a light source (often called back light) arranged at the back of the display unit to a liquid crystal display panel whose transmittance can be controlled by rotation of the liquid crystal molecule according to the applied voltage.

In the conventional liquid crystal display, the reason why the moving picture blurs is considered to be the long response time of the liquid crystal and the hold type display common to the liquid crystal display panel and plasma display panel. When the liquid crystal display panel has insufficient response speed, if the display image rapidly changes like moving picture, the transient response state of the transmittance of the time when the liquid crystal optical response-is insufficient for the image data written is also visualized. This is detected as a blur by human eyes. Moreover, when the light source is always lit, an image displayed in a certain frame is retained to the moment of rewriting to the next frame. Such a display method is called a hold type display. The mismatching between the hold type display method and the human eye visual characteristic results in a blur of moving picture, which is explained in the Technical Report IDY of the Institute of Image Information and Television Engineers, 2000-137, pp. 13-18 (vol. 24, No. 54, 2000-09).

Furthermore, as a method for suppressing blur of a moving picture caused by slow response of the liquid crystal and the human view characteristic for the hold type display method, there is described in an article in the journal a technique for periodically switching the light source. The article describes that the image quality of a moving picture is affected by a lighting ratio of the light source lit in one frame time (called lighting duty). When displaying a moving picture in which an image moves at normal speed on a high-speed response LCD panel, the image quality is improved to a permissible level by making the lighting duty to ½ or below, where image quality degradation is not felt by a viewer (permissible level is a level where a viewer can stand the blur of the moving picture). When the lighting ratio is reduced to about ¼, the viewer cannot perceive the blur of the moving picture, which is called a perception limit. The degree of improvement of the moving picture with respect to the lighting duty depends on the moving speed of the moving picture. In case of a slowly moving picture, it is possible to obtain a sufficiently preferable moving picture of the perception limit or below even if the lighting duty is about ½.

Moreover, JP-A-2000-293142 discloses a technique to improve the moving picture display on an LCD panel by periodically switching a light source.

### SUMMARY OF THE INVENTION

In order to display a moving picture with a high quality, it is necessary to provide a periodically switching light source whose lighting time is suppressed to ½ frame or below. However, in this case, a new quality degradation may be caused by the periodically switching. The object of the present invention is to solve the problem of this new image quality degradation which will be detailed below. Hereinafter, explanation will be given on the case using an active matrix type liquid crystal display unless otherwise specified.

Firstly, explanation will be given on the display principle of the active matrix type liquid crystal display and the problem of the liquid crystal display using periodically switching with reference to FIG. 14A and FIG. 14B. These figures assume a case when the entire screen where the problem to be explained is displayed remarkably in white and black for each frame. This problem also appears in a display pattern other than this although the problem degree differs.

An ordinary liquid crystal display has a frame frequency of about 60 Hz at which flicker is hardly felt and drive is comparatively easy. Here, the one frame period is about 16.7 ms (milliseconds). When voltage is applied to liquid crystal, the phenomenon reaching the light transmittance according to the applied voltage is called optical response. The time required for the liquid crystal to reach to the light transmittance according to the applied voltage after the voltage is applied is called optical response time of the liquid crystal. When the start transmittance of the liquid crystal display is 0% and the transmittance to be reached is 100%, the optical response from 10% to 90% is called a rise time tr and the optical response from 90% to 10% is called a fall time tf. When simply called an optical response time of liquid crystal, the sum of the both response times is used as follows.

t_{R}=tr+tf (Equation 1)

Here, explanation will be given on a case using a liquid crystal display mode of in-plane switching method and a liquid crystal material having such an optical response characteristic that the rise time is almost identical to the fall time which is 4 ms. Moreover, scanning refers to an operation of successive selection of each row for displaying one image and the time required for completing the scanning is called a scanning period. Moreover, when a row is selected, the time selecting the row for writing image data on the row pixels is called a selection period. The time required for writing from the uppermost row to the lowermost row of a screen is called a frame write time. The frame write time divided by the one frame time is called a duty ratio. Hereinafter, write having a write duty of ½ or below will be referred to as a high-speed write. As the write duty ratio increases, the write timing difference between the top and bottom of the screen increases. In FIG. 14A, the write duty ratio is ½. Accordingly, the write timing difference between the uppermost row and the lowermost row is about 8.3 ms. Image data writing into a pixel means applying voltage to the liquid crystal so that the liquid crystal exhibits a desired transmittance.

FIG. 14A shows an image display sequence showing relationship between the voltage (Vg1 to Vgn) applied to each row wiring and an image signal voltage 115 (Vdata) for writing. FIG. 14A also shows liquid crystal transmittance response waveforms R1, Rn/2, and Rn at the uppermost row, row 1, at the central row, row n/2, and at the lowermost row, row n on the screen for the lighting period 301. FIG. 14B shows brightness distribution for the longitudinal position when white and black display is repeated over the entire screen for each frame of the liquid crystal display using the conventional periodically switching.

As shown in FIG. 14A, when using the conventional scan method for successively writing an image signal voltage 115 (Vdata) from the top to the bottom of the screen and periodically switching the light source in synchronization with the liquid crystal response at the central portion in the vertical direction, it is possible to obtain a preferable brightness at the central portion of the screen. However, at the upper portion or the lower portion, the liquid crystal starts to respond to the image data of the next frame or the back light lighting starts while the liquid crystal response is not sufficient. Accordingly, as shown in the hatched areas where the transmittance response 302a of the uppermost row of the screen, the transmittance response 302b of the center row of the screen, the transmittance response 302c of the lowermost row of the screen, and the lighting period of the back light are overlapped, the screen brightness during white display is reduced toward the top and the bottom of the screen.

FIG. 14B shows this brightness change as characteristic dependent on the vertical position on the screen. In the same way as FIG. 14A, the characteristic curve 303 indicating the brightness distribution in the vertical, direction in-the screen is lowered toward the top and the bottom from the center of the screen and this can be recognized as brightness inclination. This brightness inclination is generated by a liquid crystal response time difference depending on the position when the write scan is performed from the upper most row to the lowermost row by the active matrix and the light source is periodically switched.

FIG. 15 shows an equivalent circuit of an active matrix type liquid crystal display. One-row image data is transferred to a drain driver 107 before the selection period of each row starts, so that as soon as the electric potential for setting the TFT 203 to the ON state is supplied to the row wiring 201 by the gate driver 106, the electric potential corresponding to one-row image data is supplied to the row wiring 202 by the drain driver 107. Thus, the electric potential depending on the image data is effectively supplied via the TFT 203 to the pixel electrode 210. The potential difference between the pixel electrode 210 and the common electrode 204 is charged to the pixel capacitance 208 and the storage capacitance 205 connected in parallel.

Upon end of the selection period, the electric potential for setting the TFT 203 to the OFF state is supplied to the row wiring 201 and one-row write is complete. Charging of the pixel capacitance 208 and the storage capacitance 205 is completed within a very short time as compared to the liquid crystal optical response. Here, the light transmittance of the pixel capacitance 208 is changed by the absolute value of the given voltage but does not depend on the polarity of the voltage. When performing a normal drive without performing periodically switching or high-speed write, the aforementioned write is started from the uppermost row and successively advances to the lower row, thereby completing image write of one frame by using almost identical time for each frame. Accordingly, even when displaying one image, the write operation start timing at the uppermost row and the lowermost row differs by about 1-frame time.

On the other hand, when the periodically switching is performed with duty ratio of ½, the write is completed in ½ frame and the write timing difference between the uppermost row and the lowermost row is ½ frame time, which is about 8.3 ms. Furthermore, by reducing the write duty ratio, it is possible to reduce the write timing difference between the upper and the lower rows. However, when the write duty ratio is reduced, i.e., when the write speed is increased, the voltage error of write into the pixel is increased, deteriorating the image quality. Among TV and image displays for PC monitors, in order to improve the moving picture performance in a high-resolution TV having a plenty of row wiring pieces, making it difficult to perform high-speed writing, it is necessary to rewrite with 60 Hz frame frequency for 1080 row wiring pieces. In this case, one-row write time is calculated to be 15.7 microseconds in a normal drive not performing periodically switching or high-speed writing. Even when a high performance low temperature poly-Si TFT is used, in the case of large-area high-resolution TV having a screen diagonal size exceeding 760 mm, the write duty ratio of about ½ is considered to be the limit of high-speed writing although this value is changed by the area size, pixel structure, wiring material, and the TFT mobility which is the write performance of the active element for writing to the pixel.

When the moving picture quality is improved by the periodically switching to suppress blur, there remains a problem of image quality caused by brightness inclination and stepwise brightness change appearing before and after the moving direction of a moving picture moving at a high speed and displayed. This image quality degradation is called an periodically switching ghost image because a double image is seen during periodically switching. The ghost phenomenon is a term used in the normal television receiver for receiving television programs. In this case, electric waves are multi-path-reflected by buildings and other obstacles, causing a plurality of radio wave propagation paths having a time difference, which are received by the receiver, generating the ghost. The ghost phenomenon handled in this invention is a phenomenon characteristic for the moving picture display using a periodically switching light source. Since the cause the different, this will be referred to as an periodically switching ghost.

Referring to FIG. 16A and FIG. 16B, explanation will be given on the periodically switching ghost handled in this invention. FIG. 16A schematically shows the ghost image generation in a liquid crystal display having an periodically switching light source and displays an display pattern 311 of a black longitudinal bar having an appropriate width moving from left to right. In this case of display, since the lighting timing of the back light is set so that the most preferable display condition is obtained at the center portion in the vertical direction, display is normal at the center portion of the display unit. However, the ghost phenomenon before and after the moving direction becomes remarkable toward the top and the bottom of the screen. This is because mismatch between the back light lighting timing and the liquid crystal optical response timing becomes greater toward the top and the bottom from the center of the screen.

FIG. 16B explains the mechanism of generation of the periodically switching ghost image. Liquid crystal optical response of the uppermost row, the center row, and the lowermost row 321, 322, 323 are shown as brightness change characteristic curves when white display is followed by two black frames and again white display. When the light source lit period 301 is matched with the optical response of the central row, the liquid crystal optical response 321 of the uppermost row starts earlier than the central row and the liquid crystal optical response 321 of the lowermost row starts later than the central row. Accordingly, the back light lighting timing is not matched with the liquid crystal optical response. This causes the periodically switching ghost image.

To solve this problem, there is a method of increasing the write speed, i.e., reducing the selection time of one row, thereby reducing the timing difference between the top and bottom. However, in order to increase the write speed, there is a limit of charging time constant determined by wiring capacitance and resistance of row wiring and column wiring and a write constant determined by the charging ability of the active element writing voltage into the pixel. Accordingly, it is impossible to obtain a sufficient effect.

In the image display using periodically switching light source, two types of image degradation are perceived: brightness inclination and the periodically switching ghost image. As has been described above, the cause of these phenomena is common. Although the lighting of the periodically switching light source is uniform over the entire screen, the liquid crystal optical response is not uniform in the screen. Consequently, during a lighting period, there are a portion where the liquid crystal do not response sufficiently and a portion where the response by the next frame write is started.

In the moving picture display as an object of the present invention, like interlaced scanning mainly used in television broadcast, it is often the case that different interlaced image data are alternately transmitted in the even-number fields and the odd-number fields. However, since the liquid crystal display should rewrite all the pixels in each frame by dot sequential or line sequential progressive scanning, normally progressive scanning appropriate for liquid crystal display is performed by two-row simultaneous scanning or interlace/progressive conversion for predicting and writing the interlaced row image data. In the two-row simultaneous scanning, it is effective to change combinations of the two-row pairs for each field in order to improve the resolution such as the normal interlace drive. However, in this case, the alternating period of each pixel is extended by twice and the flicker may be remarkable.

Here, explanation will be given on the flicker, the polarity of voltage supplied to the liquid crystal, and the method to suppress the flicker. Since the liquid crystal is normally made from an organic material, its characteristic is deteriorated when DC voltage is applied.

Normally, image data given to liquid crystal of a certain pixel changes its polarity at least for each one frame. The transmittance of liquid crystal is determined by the applied voltage and does not depend on its polarity. However, when driven by using an active element, cross talk is generated by the parasitic capacitance of the active element and a leak current when the active element is turned off. Even if voltage is supplied from the drain driver so that identical voltage is applied to the pixel electrode, the voltage value actually applied to the liquid crystal slightly differs depending on its polarity. Normally, the liquid crystal display displays one frame with 60 Hz. When identical voltage is applied to the liquid crystal with the positive polarity and the negative polarity, the flicker frequency becomes a 60 Hz component and no flicker is observed.

However, in the normal liquid crystal display, brightness differs in the positive polarity and the negative polarity, and even if the image data is the same, 30-Hz flicker is recognized. In order to suppress the flicker, the frame frequency is increased. For example, display is performed with 120 Hz. Then the human naked eye having normal brightness difference distinguishing ability cannot recognize the brightness difference between the positive polarity and the negative polarity and does not recognize any flicker. However, in order to drive the liquid crystal display with a high frame frequency such as 120 Hz, it is necessary to reduce the load of write of image data. As another method of suppressing flicker, it is possible to spatially distribute the pixel written with the positive polarity and the pixel written with the negative polarity, thereby averaging the brightness difference so that the human naked eye cannot recognize any flicker. This method is widely used currently because the increase of the image data write load is comparatively small.

It is therefore an object of the present invention to provide a liquid crystal display device illuminated by a periodically switching light source and having an excellent moving picture display capability for suppressing the vertical brightness inclination and generation of periodically switching ghost image in the moving picture display.

Another object of the present invention is to provide a liquid crystal display device having no generation of flicker regardless of the moving picture type by using the interlaced drive widely used in the moving picture display in combination with a periodically switching light source for illuminating the liquid crystal display device.

According to an embodiment of the present invention, there is provided a liquid crystal display device having a periodically switching light source repeatedly turning ON and OFF at a predetermined timing and a display unit for displaying an image by controlling light transmission or reflection of the periodically switching light source according to the image data, wherein write into the liquid crystal display device in each display frame constituting an image is divided into a first write for writing into all the pixels using precharge data as representative of a plurality of pixels created according to a first algorithm and a second write for writing overwriting data created on at least some pixels according to a second algorithm, thereby displaying an image.

Furthermore, the display unit of the liquid crystal display device is an active matrix type liquid crystal display unit including a liquid crystal layer sandwiched by two substrates at least one of which is transparent, a plurality of row wires and a plurality of column wires on one of the two substrates, and active elements on the intersections between the row wires and the column wires, so that image data is written by dot sequentially or line sequentially via the active elements into the pixels arranged in a matrix.

Furthermore, precharge data used for the first write is composed of image data representative of image data of a plurality of desired rows and an image composed of the desired rows is written by the precharge data.

Furthermore, the precharge data is composed of image data extracted by every other j rows from predetermined rows.

Furthermore, the precharge data is composed of a column-direction average value of image data consisting of j rows in the vicinity.

Furthermore, the precharge data consists of data of the slowest response time in the data change from the preceding frame among the j data pieces of the same column in the image data of j rows in the vicinity.

According to another aspect of the present invention, there is provided a liquid crystal display device comprising a liquid crystal display unit including a liquid crystal layer sandwiched by two substrates at least one of which is transparent, a plurality of row wires and a plurality of column wires on one of the two substrates, and active elements on the intersections between the row wires and the column wires, so that image data is written by dot sequentially or line sequentially via the active elements into the pixels arranged in a matrix, so that an image is maintained for a certain period and displayed, and a periodically switching light source periodically turned ON and OFF in synchronization with the display timing of the liquid crystal display unit, wherein write into the liquid crystal display unit in each display frame constituting an image is divided into a first write for writing all the pixels using precharge data capable of rough image display during an OFF period of the periodically switching light source and a second write for additionally writing interpolation data on at least some of the pixels which have performed the first write, thereby displaying a detailed image, and during the first write, a plurality of rows are simultaneously selected so that image data of one of the rows is written and during the second write, the remaining image data is successively written at once or divided into a plurality of sub-fields on row basis for writing.

Furthermore, in the second writing, the remaining image data is divided into a plurality of sub-fields for writing and write polarity is reversed for each row.

Furthermore, in the latter half of the display frame, by using the image data used in the first half of the frame, third write and fourth write are added with reversed polarity.

According to still another aspect of the present invention, there is provided a liquid crystal display device comprising a liquid crystal display unit having a liquid crystal layer sandwiched by two substrates at least one of which is transparent, a plurality of row wires and a plurality of column wires on one of the two substrates, and active elements on the intersections between the row wires and the column wires, so that image data is maintained for a certain time and written by dot sequentially or line sequentially via the active elements into the pixels arranged in a matrix, and a periodically switching light source periodically turning ON and OFF in synchronization with the display timing of the liquid crystal display unit, wherein interlaced image data is input, each image data is assigned to a pair of rows, the start row is alternately changed in the odd-number field and the even-number field, in each display field constituting one image, write to the liquid crystal display unit is divided for display into a first write for high-speed writing of all the pixels during an OFF period of the periodically switching light source by using the precharge data capable of rough image display and a second write for additionally writing interpolation data to at least some of the pixels which have performed the first write, thereby displaying detailed image data, and by using the image data used in the first half of the field, a third write and a fourth write are added with reversed polarity.

Furthermore, during the first write, two pairs of rows are simultaneously selected and image data of one of the pairs of rows is written and during the second write, one pair of rows is simultaneously selected and interlaced scan on two-pair basis is performed to write the remaining image data, and in the latter half of the display field, the image data used in the first half of the field is used so that a third write and a fourth write are added with reversed polarity.

Furthermore, the write polarity in one sub-field is made identical and a selection period of an arbitrary row is overlapped with the selection period of the next row selected.

Furthermore, the periodically switching light source is lit at a desired timing after the second write is complete.

Furthermore, the potential of all the column wires are made constant while no write is performed.

Furthermore, the potential of all the column wires not performing write operation is made identical to the potential of the common electrode arranged in the vicinity of the pixels so as to supply potential to the respective pixels.

Furthermore, the liquid crystal display mode is an in-plane switching mode or the display when no voltage is applied to the liquid crystal is a normally black mode.

Furthermore, the active element for write to the pixels is a high-mobility active element.

Furthermore, the high-mobility active element is a polycrystal thin-film transistor or a single-crystal silicon transistor.

Furthermore, the light source is a light source of high-speed response.

Furthermore, the light source of high-speed response is a light emission type light source using a current/light conversion element such as an LED (Light Emitting Diode), a light source using a field emission type electron source (FED: Field Emission Display), a light source of light emission type using plasma, or a high-speed response fluorescent lamp, or a combination of them.

Furthermore, a gate driver for writing image data dot-sequentially or line-sequentially into pixels arranged in a matrix via an active element has a function to drive row wires of a plurality of rows on a predetermined number-of-rows basis and a function to drive row wires by interlacing of a plurality of rows and selectively operates one of the functions.

Furthermore, the gate driver for writing image data dot-sequentially or line-sequentially into pixels arranged in a matrix via an active element includes a shift register, a pattern selection circuit for controlling the pattern for driving the column wiring, a buffer control circuit for controlling output of a plurality of output buffers by using the logical output between the shift register output and the pattern selection circuit output signal, and a buffer circuit for controlling voltage of the scan line by the output of the buffer control circuit.

Furthermore, the lighting timing of the periodically switching light source repeatedly turning ON and OFF at a predetermined timing is controlled to be almost identical to the column moving speed of the first write.

According to yet another aspect of the present invention, there is provided a liquid crystal display device comprising a liquid crystal display unit having a liquid crystal layer sandwiched by two substrates at least one of which is transparent, a plurality of row wires and a plurality of column wires on one of the two substrates, and active elements on the intersections between the row wires and the column wires, so that image data is maintained for a certain time and written by dot sequentially or line sequentially via the active elements into the pixels arranged in a matrix, and a periodically switching light source periodically turning ON and OFF in synchronization with the display timing of the liquid crystal display unit, wherein the periodically switching light source consists of a plurality of light source blocks whose lighting timings can respectively be controlled in synchronization with the display timing of the liquid crystal display unit, the liquid crystal display device further comprising a high-speed writing circuit for increasing the speed of the writing input image data from an external image source higher than the acquisition speed and writing it in the liquid crystal display unit.

Furthermore, the number p of the light source blocks and the ratio q of the image acquisition speed with respect to the write speed are both greater than 1.

Furthermore, a product p×q of the number p of the light source blocks and the ratio q of the image acquisition speed with respect to the write speed is greater than 3.

Furthermore, the high-speed writing circuit for increasing the speed higher than the acquisition speed when writing into the liquid crystal display unit is a circuit for dividing in each display field constituting one image, write to the liquid crystal display unit into a first write for high-speed writing of all the pixels during an OFF period of the periodically switching light source by using the precharge data capable of rough image display and a second write for additionally writing detailed image data to at least some of the pixels which have performed the first write.

According to still yet another aspect of the present invention, there is provided a liquid crystal display device comprising a periodically switching light source repeatedly turning ON and OFF at a predetermined timing and a display unit for displaying an image by controlling the light transmission or reflection of the periodically switching light source according to the image data, wherein in each display frame forming one image, the write to the liquid crystal display device is divided into four sub-frames and adjacent odd-number rows and adjacent even-number rows are made into pairs, so that in a certain frame, in a first sub-frame, the one pair together with image data of the odd-number rows is written, in a second sub-frame, image data of the even-number rows is written only in the even-number rows of the pair rows, in a third sub-frame, image data of odd-number rows is written only in the odd-number rows of the pair rows, and in a fourth sub-frame, image data of the even-number rows is written only in the odd-number rows of the pair rows; and in the next frame, in a first sub-frame, the one pair row together with the image data of even-number rows is written, in a second sub-frame, image data of odd-number rows is written only in the odd-number rows of the pair rows, in a third sub-frame, image data of odd-number rows is written only in the odd-number rows of the pair rows, and in a fourth sub-frame, the image data of the odd-number rows is written only in the odd-number rows of the pair rows.

Furthermore, as for the image data polarity, the first sub-frame and the fourth sub-frame have identical polarity, the second sub-frame and the third sub-frame have identical polarity, and the polarity of the first and the fourth sub-frame is different from the image data polarity of the second and the third sub-frame, and in each frame, polarity of an image data written is reversed in each sub-frame.

Other objects, features and advantages of the invention will become apparent from the following description of the embodiments of the invention taken in conjunction with the accompanying drawings.

### BRIEF DESCRIPTION OF THE DRAWINGS

FIG. 1 shows a drive sequence of a liquid crystal display device according to a first embodiment of the present invention.

FIG. 2 shows an equivalent circuit in the liquid crystal display device in the first embodiment of the present invention.

FIG. 3 graphically shows an effect obtained by the first embodiment of the present invention.

FIG. 4 shows a system configuration of the first embodiment of the present invention.

FIG. 5 shows a drive sequence of the liquid crystal display device in the first embodiment of the present invention.

FIG. 6 shows an equivalent circuit of a main portion of a gate driver used in the first embodiment of the present invention.

FIG. 7 shows a drive sequence of the liquid crystal display device according to a modified example of the first embodiment of the present invention.

FIG. 8 shows a drive sequence of a second embodiment of the present invention.

FIG. 9 shows a drive sequence of a modified example of the second embodiment of the present invention.

FIG. 10 shows a drive sequence of a third embodiment of the present invention.

FIGS. 11A and 11B explain the principle of precharge.

FIG. 12 shows a system configuration of a fourth embodiment of the present invention.

FIG. 13 shows a drive sequence in the fourth embodiment of the present invention.

FIGS. 14A and 14B show a drive sequence and brightness distribution in a conventional liquid crystal display device.

FIG. 15 shows an equivalent circuit of a liquid crystal display unit of the conventional liquid crystal display device.

FIGS. 16A and 16B explain problems of the conventional liquid crystal display device.

FIG. 17 shows a drive sequence in a fifth embodiment of the present invention.

### DESCRIPTION OF THE EMBODIMENTS

Description will now be directed to embodiments of the present invention with reference to the attached drawings.

(Embodiment 1)

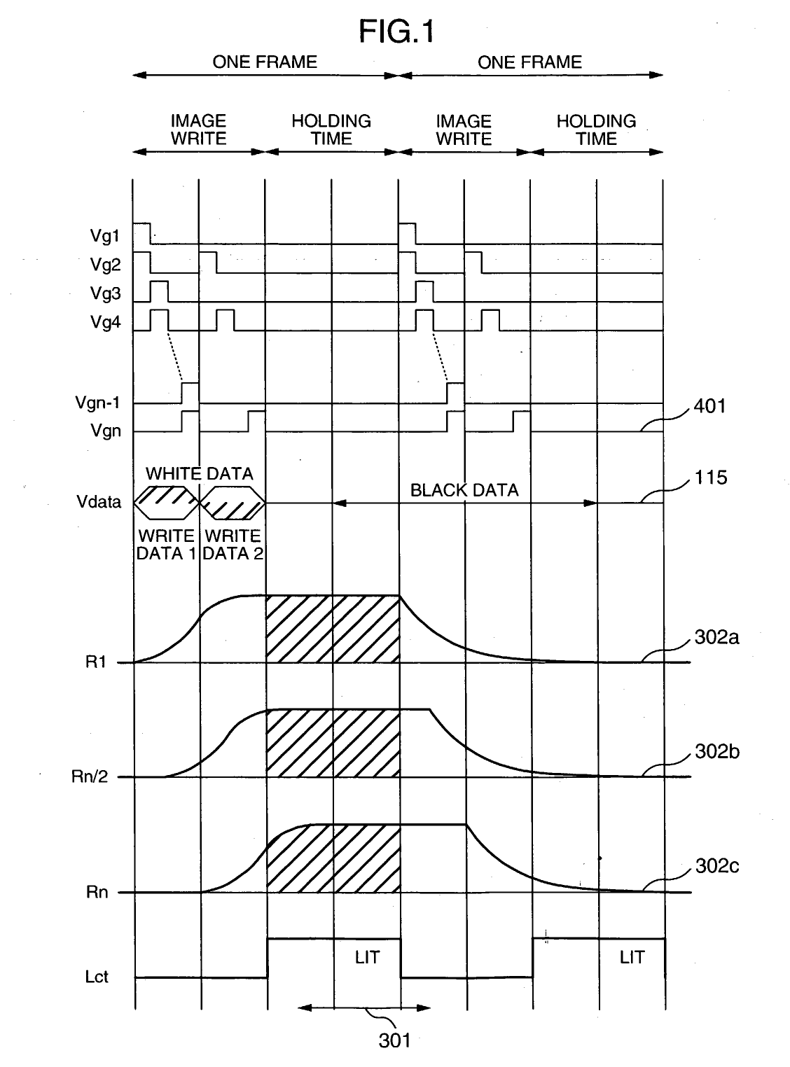

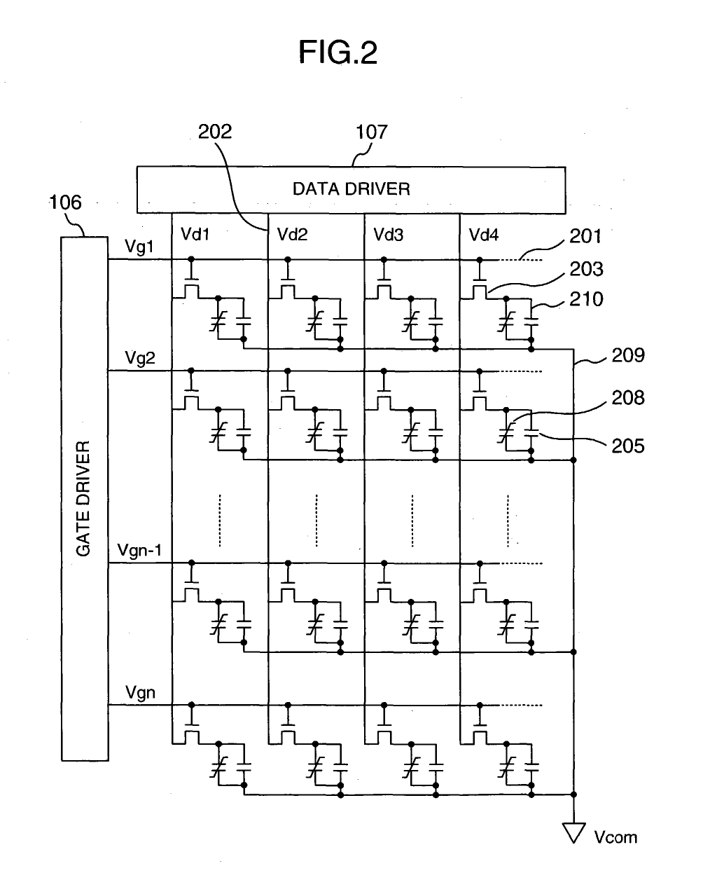

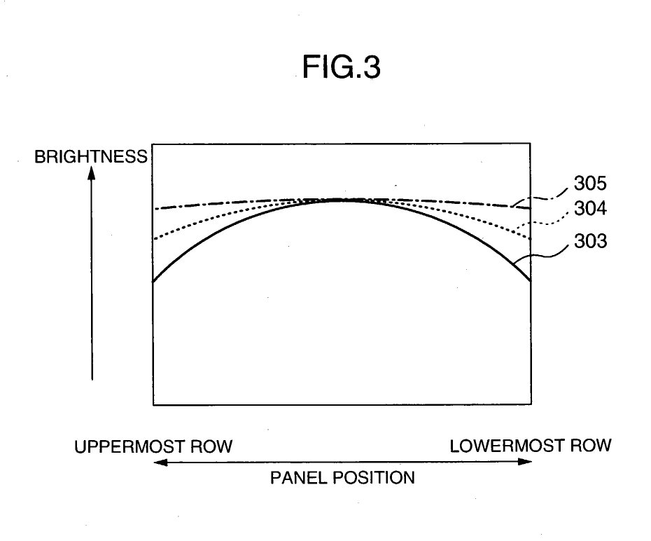

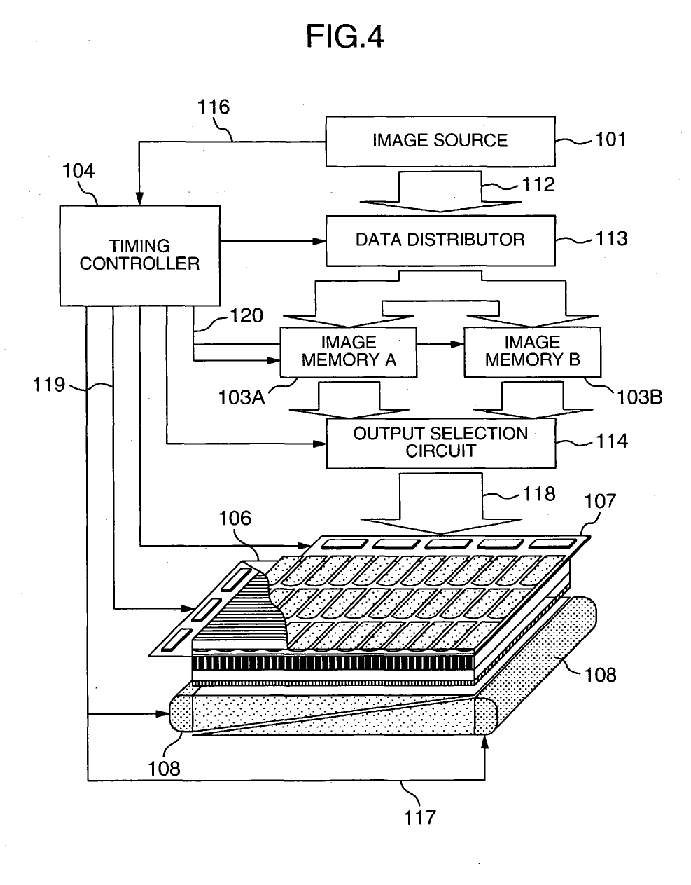

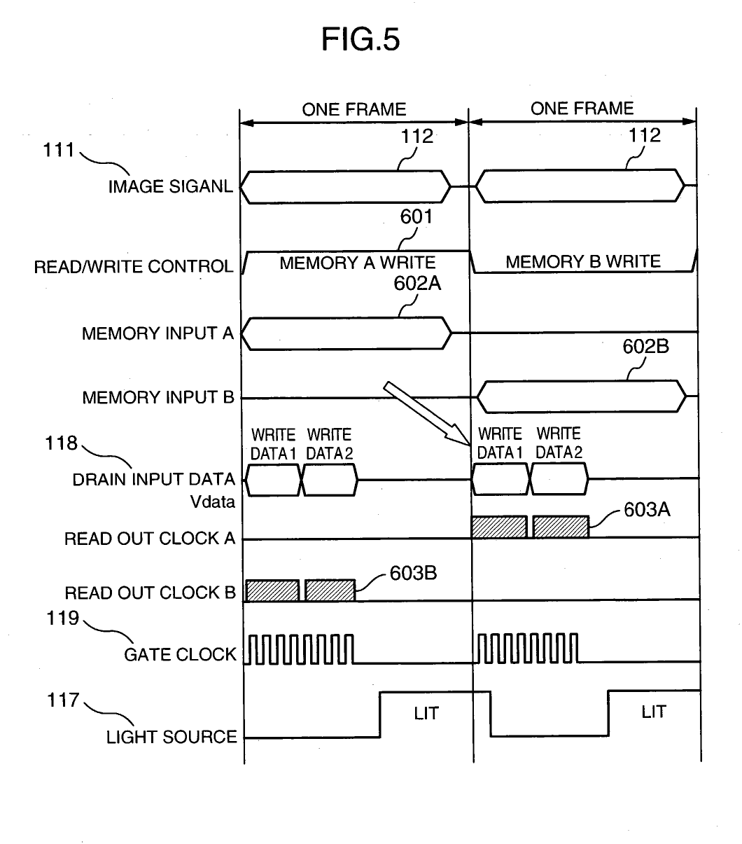

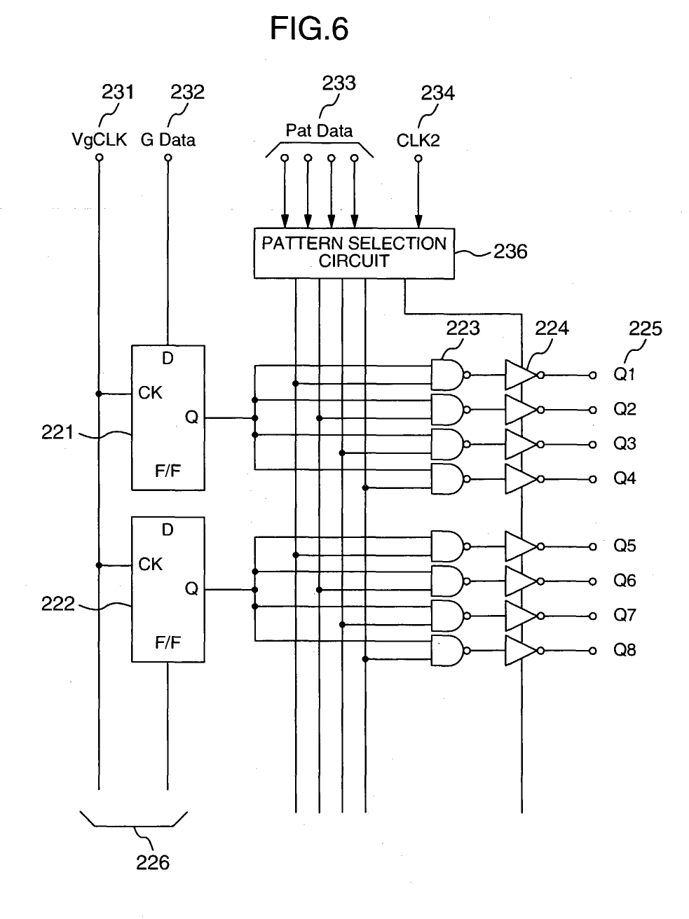

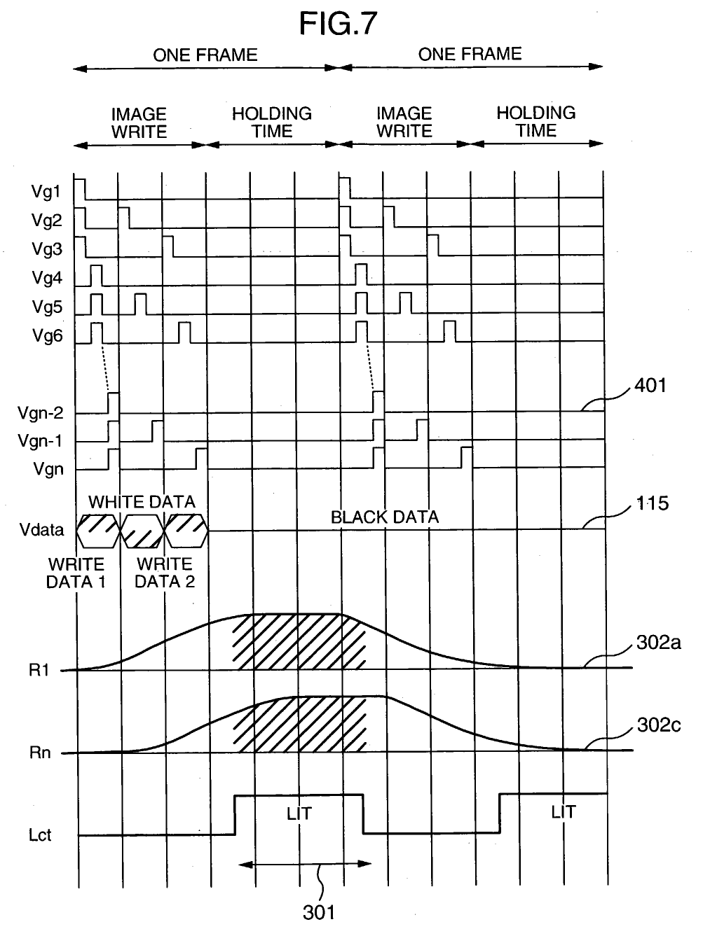

Explanation will be given on a first embodiment of the present invention with reference to FIG. 1 to FIG. 7. FIG. 1 shows a drive sequence of a liquid crystal display device according to a first embodiment of the present invention. FIG. 2 shows an equivalent circuit in the liquid crystal display device in the first embodiment. FIG. 3 graphically shows an effect obtained by the first embodiment through two types of characteristics. FIG. 4 shows a system configuration of the first embodiment. FIG. 5 shows a drive sequence of the liquid crystal display device or the present system. FIG. 6 is a circuit diagram of a gate driver used in the first embodiment. FIG. 7 shows a drive sequence of a modified example of the first embodiment. In the explanation hereinafter, drive to write at high speed into all the pixels using precharge data capable of rough image display will be referred to a data precharge drive.

The present drive method uses a data precharge drive for high-speed writing of all the pixel electrodes not depending on a place on the screen according to rough image information with a comparatively low resolution. Especially in the write method using the conventional periodically switching light source, there is a large time temporal difference between the light source lighting timing and the liquid crystal optical response. Accordingly, an image display of high contrast ratio having no generation of brightness inclination is realized in the entire display area including the top and the bottom of the display screen where brightness tends to fluctuates and periodically switching ghost image is easily generated. Simultaneously with this, it is possible to perform a highly-reliable display while suppressing moving picture quality degradation due to periodically switching ghost image.

As for the resolution of the display image, a rough image of low resolution is written by the first write. Here, the light source is not lit and the low resolution is not recognized. After a high-resolution display is performed by the second write, the light source is switched to ON state. Thus, a moving picture of high quality can be realized without lowering the resolution. Moreover, a still image is also displayed in the same procedure as the moving picture. Thus, it is possible to realize display having no difference in display quality between the moving picture and the still image.

The present embodiment is an example applied to a normally black in-plane switching mode in which black display is obtained when voltage of threshold value or below including no voltage is applied. Explanation is given on an example of in-plane switching mode but the present embodiment can be widely applied to a liquid crystal display device using an illumination optical system such as a back light and a projection light source like a TN mode, VA mode, and MVA mode having normally white or normally black display mode or a projection liquid crystal display device.

Explanation will be given on the equivalent circuit of the display unit in FIG. 2. Basic configuration is almost identical to a conventional liquid crystal display device. In the vicinity of intersection of row wiring and column wiring arranged in a matrix state, there is arranged an active element TFT 203 composed of a thin film transistor (TFT) controlling voltage write into the pixel electrode. The TFT 203 has a gate terminal connected to the row wiring and a source terminal and a drain terminal connected the column wiring and pixel electrode, respectively. Since the in-plane switching mode is used, a common wiring 209 is arranged on the same substrate as the other circuit elements such as the TFT 203. Accordingly, each common wiring is used commonly by each row and extended in the longitudinal direction of the row wiring (hereinafter, referred to as a row direction), so as to be unified at the end portion to control the common wiring potential Vcom by a variable power source using an operational amplifier.

In this embodiment, the common wiring is extended in the row direction. However, it is also possible to reduce resistance by using a mesh state excluding the opening of each pixel in the entire display area or to extend the common wiring in the longitudinal direction of the column wiring (hereinafter, referred to as column direction) so as to suppress load current applied to the common wiring during write and reduce the common wiring distortion caused by writing. The common wiring of the embodiment in the in-plane switching mode like the present embodiment may be selected from the aforementioned configurations.

The present embodiment uses the column inversion driving method for maintaining the common wiring potential Vcom constant and inverting the polarity of voltage written into the pixel at least by each column. This drive method has little restriction for the common wiring and the same polarity is written to the gate wiring from the uppermost row to the lowermost row. Thus, it is possible to suppress write insufficiency due to polarity inversion by each row, thereby realizing a high-speed write. However, the drive method is not limited to a particular one. In addition to the column inversion driving method used in this embodiment, it is also possible to use dot inversion driving method performing polarity inversion for row in addition to the column inversion driving method, the common inversion driving method for alternating the common wiring potential for each row or frame so as to reduce the output voltage of the drain driver, or combination of this common inversion driving method with the aforementioned column inversion or row inversion driving method. The gate driver 106 for scanning has a function for simultaneous writing two or more rows and a function of interlaced scanning by a plurality of rows. However, it is also possible to use an ordinary scan gate driver almost in the same way by devising the input signal until the selection time of a certain scan wiring. The drain driver 107 is a driver having output terminals all capable of polarity inversion output for each adjacent output or each RGB 3 color output. In the present example, the column inversion driving method is used and the driver should have maximum voltage swing of 13V to 15V. However, when the alternation of the common wiring is used, the voltage can be reduced to about 7V.

FIG. 6 shows a circuit configuration of the gate driver used in this embodiment. Its basic configuration is identical to that of the conventional gate driver. The basic configuration of the gate driver includes a shift register supplied with gate input data 232 and having a multiple cascade of a plurality of flip-flop (hereinafter, referred to FF) and an output circuit 225 receiving output of the shift register and performing impedance conversion. The gate driver is characterized in that write is performed in unit of a predetermined plurality of rows for each block and an interlacing operation for each plurality of rows can be selected according to a predetermined sequence. In the gate driver of this embodiment, output of on FF 221 controls 4-output output circuit 225. The four outputs are the maximum number of blocks that can be driven simultaneously. By increasing the number of outputs that can be controlled simultaneously, it is possible to increase the number of types of simultaneous control that can be selected.

For example, in this embodiment, in combination with the control pattern of the pattern selection circuit 236, it is possible to select one block in 1-buffer, 2-buffer, or 4-buffer simultaneous control. The number of buffers that can be controlled simultaneously is 4-buffer control when the output of the pattern control circuit 236 is synchronized with the control clock 231 (VgCLK) of the shift register 226 and 2-buffer control when two types of patterns are generated in one clock of the control clock 231. It should be noted that when the pattern selection circuit is driven by the predetermined four types of patterns in one clock of the control clock 231, it is possible to perform operation completely identical to the conventional gate driver.

When a desired pattern is determined in advance, it is possible to constitute a sequential circuit for outputting the pattern selection circuit 236 by the desired pattern selection circuit 234 or directly input a selection pattern as pattern data 233. The output of the pattern selection circuit 236 and the output of the shift register 226 which have been output by any of the methods are input to the buffer control circuit 223 and its logic output can control the output buffer. Moreover, in order to reduce the load of the liquid crystal display device, the buffer control circuit 223 may be a three-state buffer having a high-resistance state output. Furthermore, when six buffers are controlled by one FF 221, it is possible to select among one-buffer, 2-buffer, 3-buffer, 6-buffer simultaneous control.

Explanation will be given on a method for realizing the function of the gate driver of the present embodiment shown in FIG. 6 by using a normal scan gate driver. In the normal gate driver, one FF corresponds to one output buffer. In order to drive four outputs simultaneously, it is necessary to successively input four rows of gate selection signals and four clock signals at a high speed so as to obtain a desired gate selection output. After this, a driver output is maintained for one-row gate selection time, after which four high-speed clocks are input. By repeating this scan, it is possible to obtain a desired gate driver output. Here, as the clock input speed increases within the range of the gate driver operation speed, it is possible to reduce the invalid gate output time.

Referring to FIG. 1, explanation will be given on the driving sequence according to the present invention. In a two-frame period driving sequence extracting/displaying an arbitrary row representing a main application voltage and its response waveform, first half one frame displays white and the latter half one frame displays black. In the actual image display, various image display patterns are combined to display an image. The application voltage is the image signal voltage 115 (Vdata), row wiring potential from the uppermost row gate wiring voltage Vg1 to the lowermost row wiring potential Vgn to which the gate driver output is applied, and the control signal 117 (Lct) of the light source. The response waveform is the uppermost row R1 and the lowermost row Rn about the pixel transmittance change obtained by the driving sequence. The control signal 117 (Lct) of the light source controls the light source in such a way that when High level voltage is applied, all the light sources are lit. The common wiring electrode potential Vcom is not depicted. Voltage applied is corrected considering the voltage shift generated when voltage-writing black display potential of the image signal voltage 115 (Vdata) to a pixel and the voltage shift generated when writing half tone and white image data. Thus, it is possible to prevent superimposing of DC component onto the liquid crystal and suppress remaining image and deterioration of the liquid crystal material, thereby improving the display reliability.

A sequence in one frame is divided into a first half of image data write period, a latter half of pixel voltage maintaining period, and a light source lit period around the maintaining period. Furthermore, the image data write period is divided into a first write for writing a rough image by write data 1 into all the pixels and a second write for rewriting at least some of the pixels by write data 2 so as to realize a high-resolution image display. In this embodiment, the lit period of the light source is set to about ½ of one frame period. As the lit period is decreased, the liquid crystal response time is extended to improve the moving picture performance. A lit period for one frame period is normally called a lighting duty. As this lighting duty is reduced, the brightness is lowered. Accordingly, the ½ duty of high brightness has been selected in the duty range capable of obtaining sufficient moving picture performance.

In this embodiment, as the simplest configuration for the first write, the number of simultaneously selected row wiring pieces is set to two. Thus, the rough image data write is completed in ½ of the normal image data write time. Accordingly, as shown in FIG. 1, the first write for writing the rough image data is completed in the ¼-frame time. As the rough image data used for the first write, image data of odd-number rows is used in such a manner that two rows are simultaneously selected and written. As the image data used for the second write, image data of even-number rows is written. The time difference between the uppermost row and the lowermost row is reduced from about 8.3 ms to about 4.2 ms. Even in the lowermost row, the liquid crystal response time from the voltage write to the pixel to the light source lighting has been increased from 0 ms to about 4.2 ms. The maximum voltage swing is indicated by the bandwidth of the application voltage. Actually, however, the positive polarity image data Vd+ and the negative polarity image data Vd− corresponding to the image data are applied. In the present embodiment, the write polarity example is indicated by hatching. The first write for writing the rough image is written by the positive polarity and the second write for writing the interpolation image data is written with the negative polarity. As has been described above, this embodiment is based on the column inversion drive and accordingly, voltage of inverse polarity is applied to the adjacent column wiring or column wiring on the adjacent color dot.

Consequently, the second write has written data of different polarity in the row direction also, thereby realizing dot inverse drive in which flicker is hardly recognized in the display pattern. In the actual display, generation of flicker was not observed. Moreover, since voltage is written with the same polarity in each of the first write and the second write, the voltage difference of write can be significantly reduced as compared to the conventional case in which polarity is reversed in each row during write. Thus, it is possible to perform a high-speed write. Each of the first write and the second write could written sufficiently in the ¼-frame time or below.

FIG. 7 shows a drive sequence according to a modified example of the first embodiment of the present invention. Basic configuration is identical to the first embodiment shown in FIG. 1 except for that three rows are simultaneously selected at the first write of rough image writing, thereby realizing a high-speed rough image writing of ⅙-frame time which is three times higher than the conventional example. In this embodiment, the time difference between the uppermost row and the lowermost row could be reduced to about 2.8 ms. Moreover, the second image write was performed by repeating twice three-row interlaced scanning while shifting by one row. In this embodiment, since the first write is performed by three-row simultaneous selection, if row-direction inverse drive is used, polarity is reversed by combining different polarity write between one row and two rows. In this embodiment the row-direction inverse drive is not used but the column inverse drive is used to prevent flicker. Furthermore, as means to suppress flicker, during the holding period for lighting the illumination and displaying the image, all the circuit operations are stopped to maintain a constant potential. This could completely eliminate the cross talk attributed to the connection of the wiring and pixel capacitance.

In the conventional liquid crystal display device, when a black rectangular shape is displayed, a cross talk called longitudinal smirch may be generated. In order to suppress this, row-inverse or column-inverse drive has been often used. However, in the present embodiment, there is no need of using the row-based inverse drive. In this embodiment, the common electrode potential Vcom of the holding period is set almost identical to the drain driver output voltage Vd. By stopping all the circuit operations to obtain a constant potential, it is possible to completely suppress the longitudinal smirch. However, the voltage attributed to the potential difference between the column wiring potential during the positive polarity write and the column wiring potential of the holding period is superimposed on the pixel potential during the holding period. Since this voltage is not based on the display image pattern, no longitudinal smirch is generated but the pixel voltage applied to the liquid crystal is changed. In this case, if the black write voltage fluctuates, this lowers the contrast ratio. Accordingly, in this embodiment, the common electrode potential Vcom of the holding period and the output voltage Vd of the drain driver are set to almost identical voltage so that no affect to the black display is present.

In this embodiment, in order to assure voltage writing into the pixel, a high-mobility low-temperature poly-Si TFT is used as a voltage write TFT in the pixel. In case of the normal amorphous silicon TFT, 5 to 8 microseconds are required for write time into the pixel including the write delay of the charging constant TFT as a product of the wiring load capacitance and the wiring resistance. However, by using the low-temperature poly-Si TFT, only the charging time constant by the wiring time constant should be considered and the delay can be reduced to about 3 microseconds. In this case, even if the write duty is reduced to ½ frame or ¼ frame, it is possible to realize preferable writing characteristic.

When using a reflection type liquid crystal display device based on a single-crystal silicon used in the projection type liquid crystal display device or a transparent type liquid crystal display device having a transparent conductive film obtained by chemically removing a part of the semiconductor substrate, the voltage write active element has a high drive ability, the display wiring has a short length, and the intersection has a small load. Accordingly, it is possible to realize a display device having a further smaller write time constant and a smaller time difference between the upper and the lower rows.

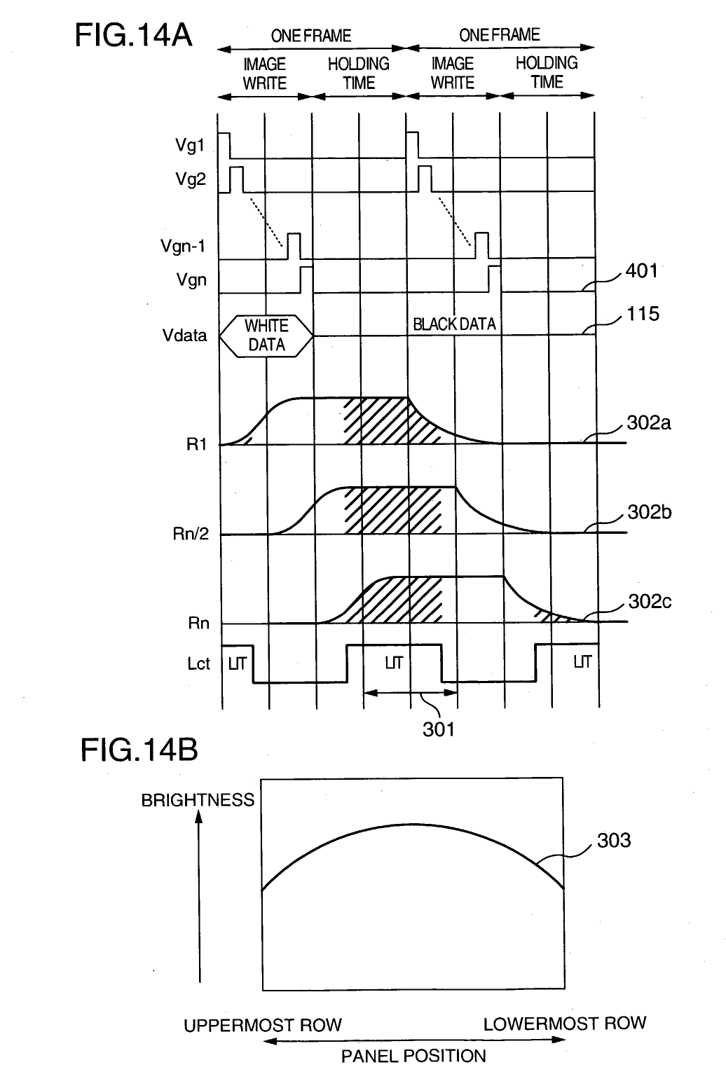

FIG. 3 shows-characteristics obtained by the present embodiment in comparison with the conventional example. In FIG. 3, the vertical axis and the horizontal axis represent the same things as in FIG. 14B showing a characteristic curve of the conventional display device. The vertical axis represents a brightness distribution. The characteristic curve 303 is obtained by the conventional display device. The characteristic curve 304 is obtained by the present embodiment using two-row simultaneous selection, and the characteristic curve 305 is obtained by the present embodiment using three-row simultaneous selection. As is clear from FIG. 3, the central portion of the screen is hardly affected by the presence/absence of the data precharge drive. Toward the top and the bottom of the screen, the brightness is lowered due to slow response when no data precharge drive is present. However, in the characteristic curves 304 and 305 of the present embodiment, the brightness lowering is hardly observed and a preferable uniform display is obtained.

In this embodiment, as the light source, an LED array capable of high-speed on/off operation is used. Since the on/off operation of the LED has response performance of 1 millisecond or below, it is possible to realize a lit time almost identical to the light source control signal 117 (Lct). Thus, it is possible to turn off the light source before start of the display change from black to white greatly affecting the contrast performance and to prevent lowering of the contrast attributed to the display state of the next frame. As for the local frame display change, the present invention performs a rough image write at high speed over the entire screen by the data precharge drive upon frame start and accordingly, it is possible to realize display optimizing the uniformity of the contrast and brightness. In this embodiment, an LED array having a sufficiently high-speed response and easily available is used as the light source. However, any light source having a high-speed response may be used.

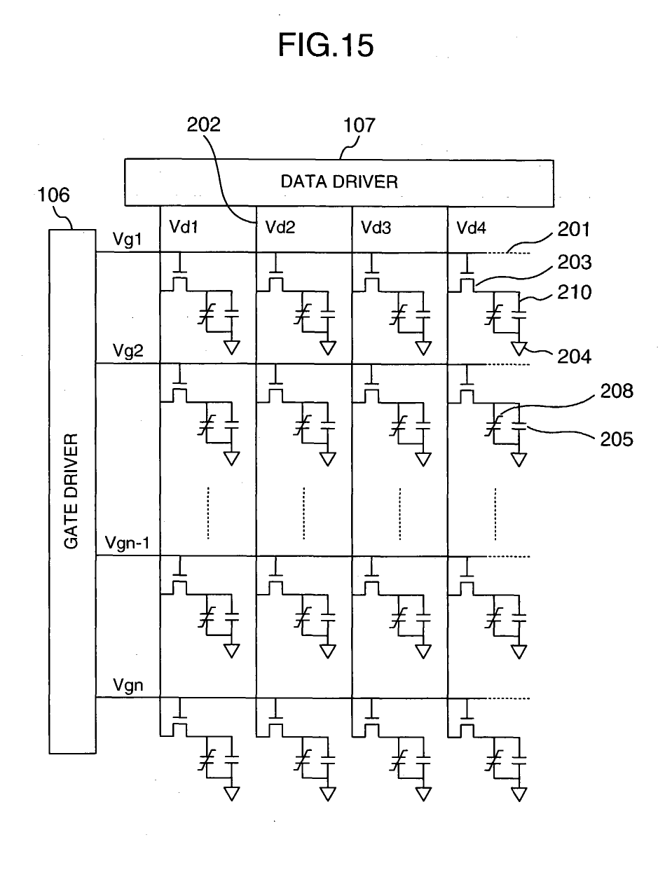

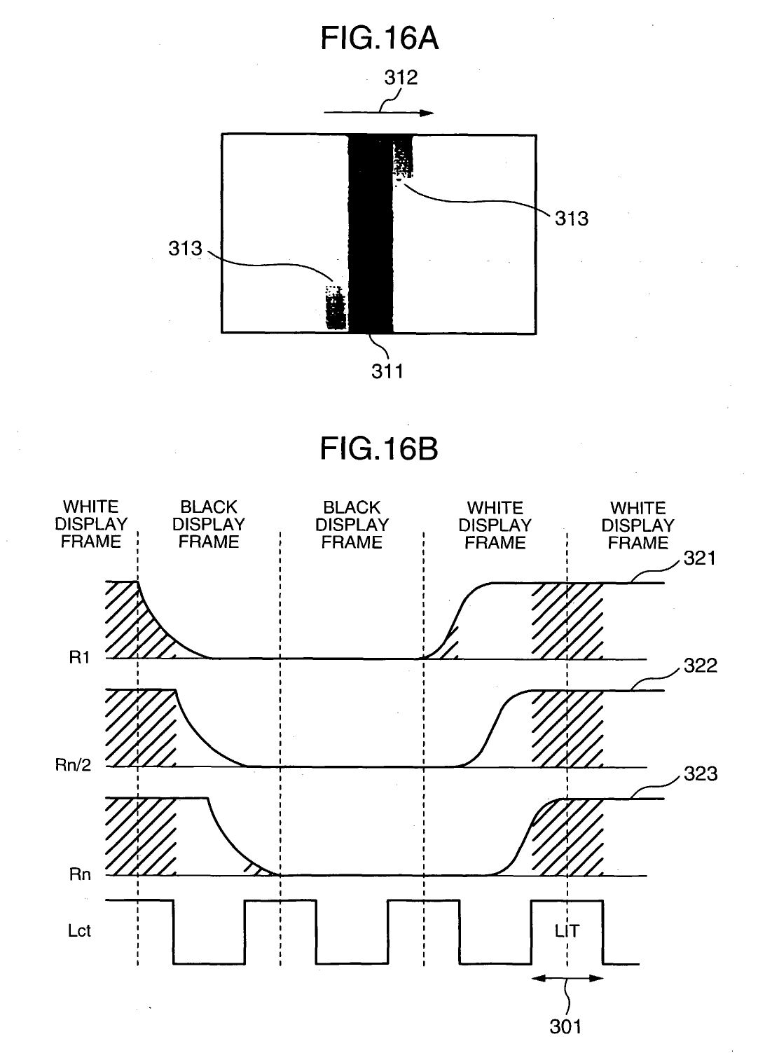

FIG. 4 shows a system configuration of a display device of the present embodiment. Furthermore, FIG. 5 shows a sequence of the memory control of the system. The system configuration and the drive sequence are almost identical to the conventional system configuration shown in FIG. 14 to FIGS. 16A, 16B except for that in order to realize data precharge drive, the gate driver 106 is configured so that a predetermined plurality of rows are written all at once for each block and interlace operation of a plurality of rows can be selected according to a predetermined sequence.

Detailed explanation will be given on the system configuration shown in FIG. 4. Image data 112 and timing signal 116 output from an image source 101 such as a digital TV tuner and a digital recording/reproduction disc device for recording/reproducing a moving picture are input to a data distributor 113 and a timing controller 104 of the liquid crystal display device of the present invention. The data distributor 113 distributes image data 112 on frame basis to one of the two-frame image memories 103 (image memory A: 103A and image memory B: 103B) for recording the image data 112. The image memory 103A and 103B are operated as a to-and-fro type buffer. When necessary, any of the image memories is selected by a selection circuit 114 and read is performed at a speed twice as much as the write, thereby completing the data transfer to the drain driver 107 in the liquid crystal display unit in ½ frame. The image memory 103 has a specific configuration as a frame memory having an address signal generation circuit. This image memory 103 is supplied with a read/write control signal from the timing controller 104 and a memory control signal 120 consisting of a control signal of an address circuit not depicted. These memory control signals 120 control read/write of the image data 112 according to the specification of the present embodiment. The same function can be obtained without using a complicated address circuit, by using a FIFO (first in first out) memory handling image data 112 of even-number rows and odd-number rows for the respective frames as the configuration of the image memory 103. The liquid crystal display unit includes a periodically switching light source 108 and its flashing is controlled by the control signal 117 (Lct) of the light source input from the timing controller 104. Moreover, the gate control signal 119 controlling the gate driver is also output from the timing controller 104.

Referring to FIG. 4 and FIG. 5, detailed explanation will be given on the drive sequence shown in FIG. 5. The basic drive sequence is almost identical to the liquid crystal display device using the conventional periodically switching light source shown in FIG. 14 to FIGS. 16A, 16B. Image data is written at a high speed during a period shorter than one frame and the light source is lit at a timing when the liquid crystal responds to a certain degree. The difference from the liquid crystal display device using the conventional periodically switching light source is that instead of row-successive scan for writing image data of the entire display screen from the uppermost row one by one, two sequences are added, i.e., rough image data is written at a high speed as a plurality of rows simultaneous write sequence and after this, image data interpolating the rough image data is written as an interlaced scan sequence. The image memory 103 has an address generation circuit for reading from the image memory 103 the write data 1 as image data used for the plurality of rows simultaneous write sequence and the write data 2 as data used for the interlaced scan sequence. In this embodiment, the rough data, i.e., the write data 1 is image data of odd-number rows and the interpolation image data, i.e., the write data 2 is image data of even-number rows. Accordingly, this read out circuit can be realized by giving the least significant bit of the address generation circuit as a selection signal from outside the address generation counter. The write data 1 for writing rough image data may be data of the odd-number rows or the even-number rows.

According to the drive sequence, explanation will be given on the operation of the image memory A of FIG. 5. Frame-basis image data 112 input from the image signal 111 is distributed to the image memory 103 by the signal distributor 113 and its control signal, i.e., a read/write signal 601. The read/write signal 604 sets the image memory 103A to a write mode and the image memory 103B to a read mode. In the left frame in FIG. 5, image data is stored in the image memory A and in the next memory, image memory A: 103A is set to read mode by the read/write signal 601. The stored image data 602A is transferred to the drain driver 107. Here, a read clock pulse 603A from the image memory A: 103A is input to the address generation circuit not depicted. Firstly, image data of odd-number rows is read from the image memory A and input as write data 1 to the drain driver 107. Subsequently, setting of the address generation circuit is modified, so that image data of even-number rows is read out from the image memory A and input to the drain driver 107. At this time, a gate control signal 109 is input from the gate driver 106 in synchronization with the output timing of the drain driver 107. By this series of sequences, voltage write is performed to the liquid crystal display unit. The light source is lit by the light source control signal 117 after elapse of a predetermined time after rough voltage write to all the pixels is complete.

In this embodiment, the light source is lit after the write data 2 is written. Considering a liquid crystal response delay in the next frame, the light source is lit after elapse of a predetermined time (such as 2 to 3 ms) after the write data 2 is written and the light source is extinguished after elapse of a predetermined time after the write start of the next frame. Thus, it is possible to obtain the highest brightness and ghost-free display condition. Thus, one-frame image write and lighting sequence is complete. By repeating this sequence, it is possible to continue the display operation.

As a modified example of the present embodiment, when performing the rough image data write by three-row simultaneous write, the memory area of the image memory 103 is divided in advance for storing the write data 1 and the write data 2. More specifically, a three-value counter is provided in the data distributor 113 for counting the input image data pieces. Only when the three-value counter is cleared, data is stored in a memory area of the write data 1 and the remaining is stored in a memory area of the write data 2. Thus, when reading the data, by setting a signal specifying the memory area or a flag for the memory, desired read out data can be transmitted to the drain driver only by simply increasing the read out address by the address generation circuit.

As has been described above, in this embodiment, by combining the high-speed rough image data write by two-row or three-row simultaneous selection with a subsequent detailed image data write, it is possible to prevent periodically switching ghost image in the moving picture display and realize preferable display having no brightness inclination.

(Embodiment 2)

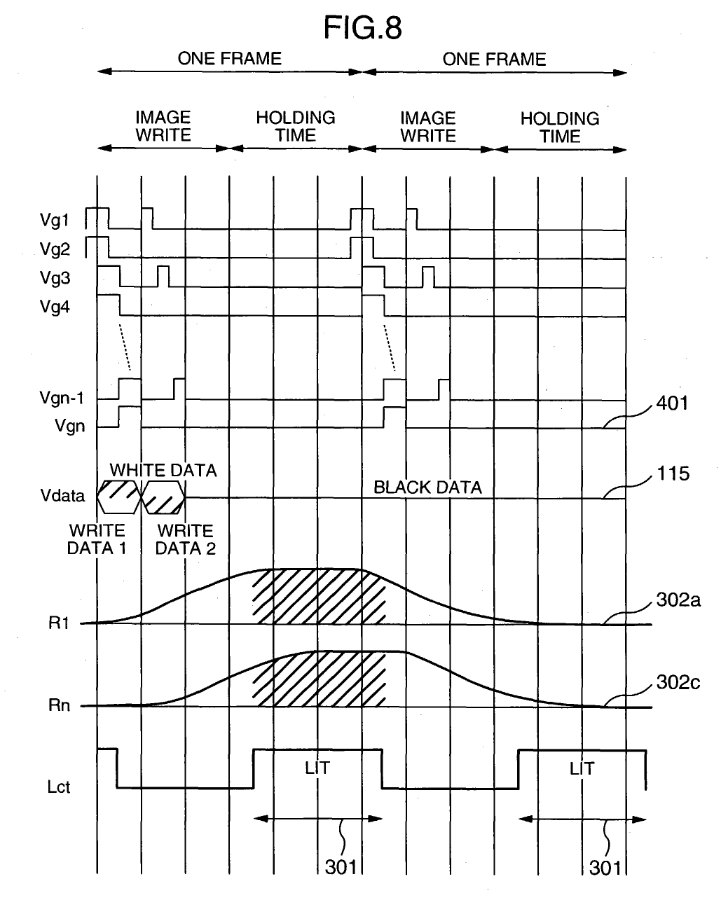

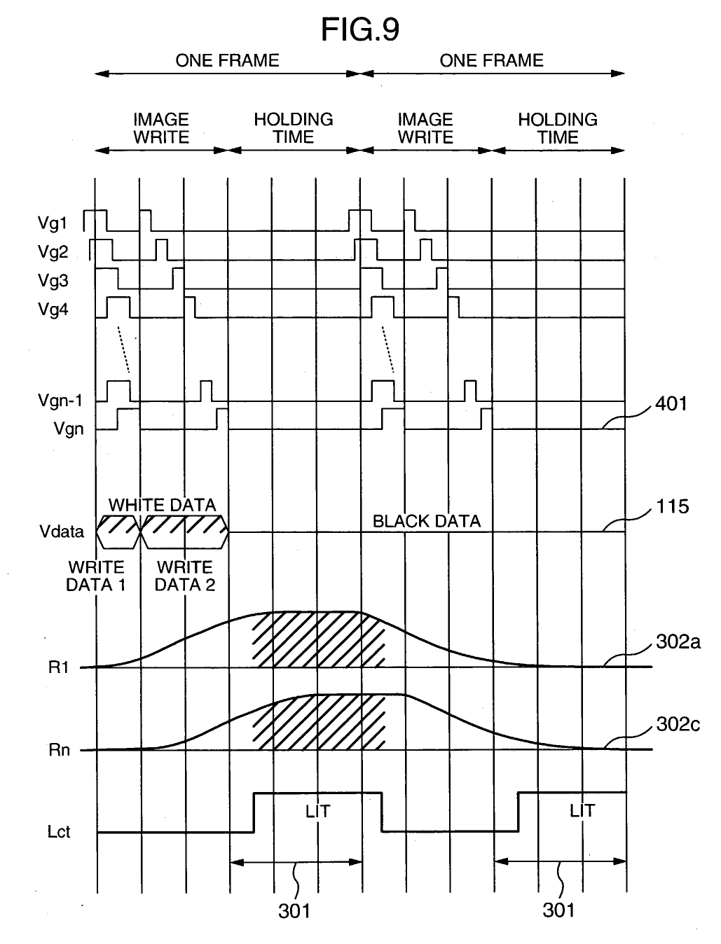

Description will now be directed to a second embodiment with reference to a drive sequence of FIG. 8 and FIG. 9.

The second embodiment is characterized in that in order to realize high-speed data precharge drive for writing a rough image in the first write, overlap drive is used for providing a simultaneous selection period for an plurality of adjacent rows while in the second write, all the pixels are written on the first write. This embodiment uses a normally black in-plane switching mode and has a basic configuration identical to the first embodiment including the configuration of the active matrix liquid crystal display unit, the gate driver, and the drain driver.

Hereinafter, detailed explanation will be given on FIG. 8. As for the first write, in order to assure write by extending the gate selection period, an overlapped period is provided for the gate selection period. That is, the gate selection period of each scan wiring is set longer than the drain voltage switching period according to the image information. The drain voltage may be a voltage corresponding to the image information of all the pixels on the screen applied at a high speed. However, it is enough to write rough image information with a small time difference. Accordingly, it is possible to switch drain voltage for writing by selecting rough image data for each several rows. Like in the first embodiment, FIG. 8 shows a two-frame drive sequence in which the left frame displays a white image and the right frame displays a black image. In the image signal voltage 115 (Vdata), the hatched portion shows the actual write polarity in an arbitrary column wiring. Among the white data, the first write is written with the positive polarity, the second write is divided into two sub-frames, and the entire image is written. Here, in writing the write data 1 for writing the rough image data, a sufficient gate selection period can be obtained because the overlap drive is used for the first write.

Accordingly, it was possible to obtain a high-speed write, ¼ time of the second write. In the second write, two sub-frames are used: the first sub-frame having a polarity opposite to the first write, i.e., a negative polarity and the second sub-frame having the same polarity as the first write because it is near to the lighting timing of the light source. This reduces the write load and significantly improves the writing voltage accuracy. Moreover, as the rough image data used in the first write, the first sub-frame data in the second write is used, so as to eliminate cross-talk cause by the write shortage in the first write and the overlap drive between the adjacent rows, thereby significantly reducing the error in the second write. As for the second sub-frame write in the second write, it is considered that some unwritten state voltage is generated by the polarity inversion but the unwritten voltage can be estimated from the write data of the preceding frame and can be corrected by a signal processing. In this embodiment, the voltage was corrected according to the image signal voltage 115 (Vdata) of the preceding frame.

Referring to FIG. 9, explanation will be given on a modified example of the present embodiment. The first write is completely identical to the present embodiment shown in FIG. 8 using the overlap drive for providing a simultaneous selection period for a plurality of adjacent rows and its explanation is omitted. As for the second write, without providing a sub-frame, the method used drives each row from the uppermost row to the lowermost row. By successively writing from the uppermost row to the lowermost row, it is possible to obtain a write characteristic difference between adjacent rows at a level identical to the conventional drive method, thereby realizing a uniform display. As for the voltage write polarity, polarity was reversed for each column according to the column inversion drive from the viewpoint of the write performance. For the row direction, for example, a low-temperature poly-Si is used as a pixel active element, so as to perform dot inversion drive in combination with a row inversion drive for reversing the polarity for each row by a high-speed pixel voltage write. In this embodiment, the column inversion drive alone is used but no column-direction cross-talk was observed and it was possible to obtain a preferable display state.

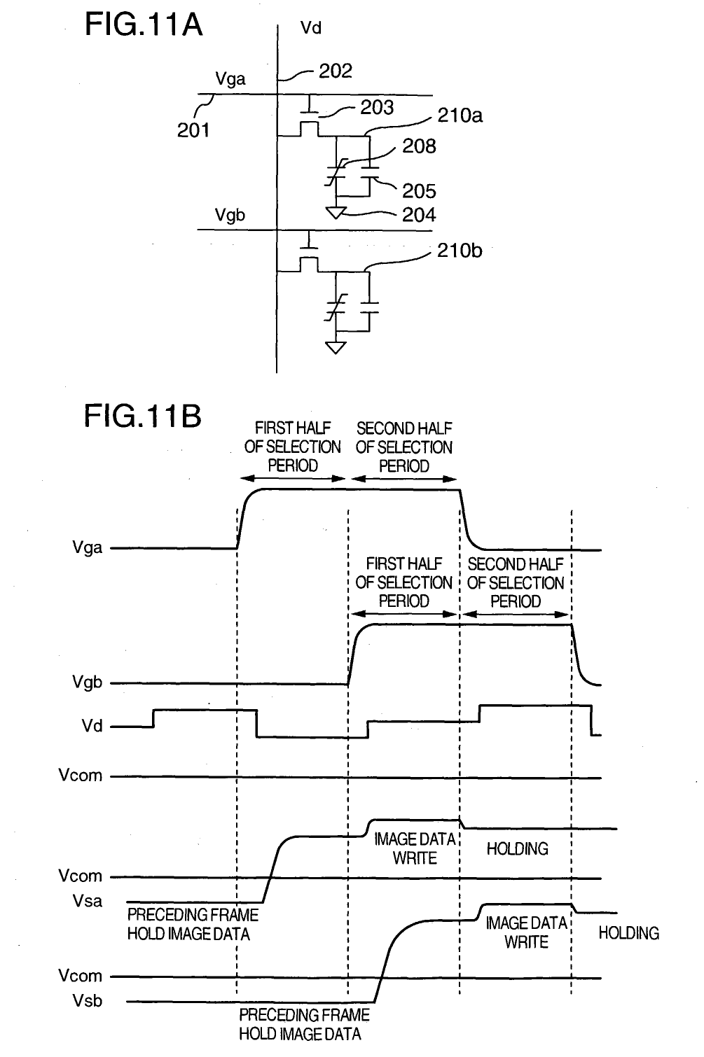

Referring to FIG. 11A and FIG. 11B, explanation will be given on the effect of the overlap drive. Firstly, by selecting a plurality of rows, it is possible to significantly reduce the affect of the load of the capacity connected to the row wiring 201 and the charge delay caused by the wiring resistance. In this embodiment, the wiring resistance is about 3 kΩ and the wiring capacity is about 400 pF. Accordingly, the charge time constant τ is τ=1.2 microseconds. Normally, in order to obtain a sufficient write characteristic, the selection time required is 4 to 8 times more. On the other hand, the selection time of the first write period is about 7 microseconds when no overlap drive is used. Thus, the overlap drive functions effectively. Next, explanation will be given on the load reduction. When the frame inversion and the column inversion drive are used, image data written into the pixels belonging to the same column have the same polarity. By overlapping the selection period of the preceding column selected, it is possible to apply the polarity written in the frame in advance by the image data of the preceding row or rows selected. Thus, the image data write can be performed easier.

FIG. 11A and FIG. 11B, as an example, pay attention on pixels of two rows in one column and it is assumed that image data of positive polarity is written in this column in a frame. Firstly, the upper pixels are considered. Before the selection period, image data of the preceding frame is held and accordingly, for the potential Vcom of the common electrode 204, a potential of negative polarity is held for the pixel electrode Vsa 210a.

When the selection period is set and the application voltage 401 Vga becomes a high potential, the TFT 203 turns ON, the potential of positive polarity of the column wiring 202 is supplied to the pixel electrode 210a, and during the first half of the selection period, the common electrode 204 is charged with positive polarity. During the latter half of the selection period, image data contributing to the display is written with positive polarity. Upon completion of the selection period, the row wiring potential Vga becomes low potential and the pixel voltage Vsa 210a holds potential of positive polarity written to the common electrode 204 during the latter half of the selection period. When the lower pixels are observed, before the selection period, the image data of the preceding frame is held and accordingly, potential of negative polarity is held in the pixel electrode Vsb for the potential Vcom of the common electrode 204.

When the selection period is set in and the row wiring potential Vgb becomes high potential, the TFT turns ON, the potential of the positive polarity of the column wiring 202 is supplied to the pixel electrode 210a, and during the first half of the selection period, charging with the positive polarity is performed for the common electrode 204. Here, the potential of the positive polarity supplied to the pixel electrode 210b is the potential supplied during the latter half of the selection period of the upper pixels. During the latter half of the selection period, the image data contributing to the display is written with positive polarity. Upon completion of the selection period, the row wiring potential Vgb becomes low potential and the pixel electrode 210b holds potential of positive polarity written to the common electrode 204 during the latter half of the selection period.

Thus, by overlapping the half of the selection period on the preceding row selected during a selection period of a certain row, it is possible to charge in advance the holding potential of the inverse polarity of the preceding frame into the polarity of the current frame with the image data written in the row preceding by one. Thus, it is possible to obtain an effect to easily write image data contributing to the display during a latter half of the selection period.

According to the present embodiment, in the first write for writing high-speed rough image data, a plurality of adjacent rows are written with the same polarity and by overlapping with one other, so as to significantly reduce the write time. This reduces the writing timing difference between the upper and lower rows in the display unit and the response time, thereby realizing a liquid crystal display device having little periodically switching ghost in the moving picture display and little upper/lower brightness inclination. Moreover, by writing all the image data by the second write, it is possible to realize a liquid crystal display device of high image quality having no image display irregularities due to write insufficiency or mismatch of write conditions.

(Embodiment 3)

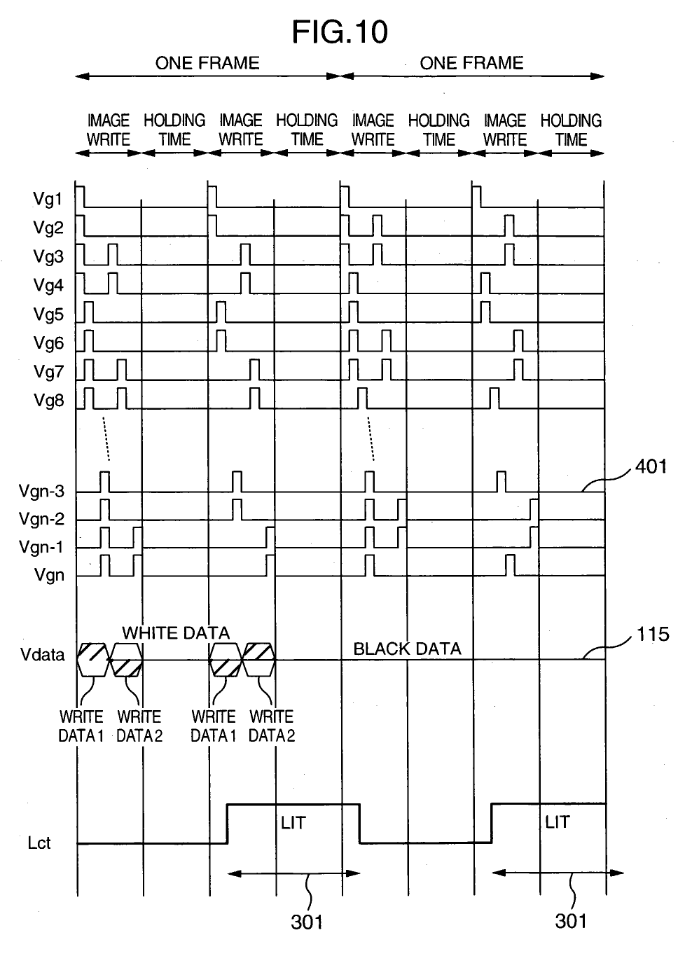

Referring to FIG. 10, explanation will be given on a third embodiment of the present invention. Like the first embodiment, this embodiment is also applied to the normally black in-plane switching mode. However, the display mode is not limited to a particular one. The present embodiment can preferably be applied to an interlaced drive in which images of odd-number rows and even-number rows used normally for the broadcast image data and accumulation type moving picture data are displayed for each field and provides a display drive method and display device maintaining a high image resolution. FIG. 10 shows a drive sequence as an essential portion of the present embodiment. Basic drive sequence is identical to that of the first embodiment but according to the interlaced data, the image data transmission method to the liquid crystal display device and the corresponding panel drive method are different.

Display image data constituted according to the interlaced drive specification consists of an odd-numbered field composed of odd-number row image data and an even-number field composed of even-number row image data. When the interlaced image data is applied to a non-interlaced drive type display such as a liquid crystal display, the two-row simultaneous drive method for displaying the same data for two rows is often used. Here, the non-interlaced type display device is based on such a method that image data of the odd-number rows and the even-number rows are displayed on the same frame. This is equivalent to that the two-row simultaneous drive converts the one-field image data into one-frame image data. In the display device using the two-row simultaneous drive method, by changing the row combination to be selected in the odd-number frame and the even-number frame according to the row information of the original image data, it is said to be possible to display resolution of about 70% of the entire number of rows even if a Kell factor indicating actual resolution is considered. For example, when an interlaced image of 1080 rows is input to a 1080-row liquid crystal display device, by employing the two-row simultaneous drive and the drive for changing the selection row combination for each frame, it is possible to obtain an image resolution of 756 rows or above. Accordingly, it is possible to realize the optimal high-resolution image in the current broadcasting on a commercial basis.

The present embodiment is based on in-frame AC drive and is characterized in that the positive polarity and the negative polarity are applied to the same image data for an equal time within a frame, thereby completing alternation of the liquid crystal. For this, in this embodiment, no DC bias is superimposed on the liquid crystal in any of the moving pictures and it is possible to prevent residual image or burn-in image without devising the image processing.

Hereinafter, detailed explanation will be given with reference to FIG. 10. Basic configuration and basic drive method are identical to those of the first embodiment. However, in one frame, the first write is performed once and the second write is performed three times in such a manner that each write polarity is reversed in a frame, thereby realizing AC within a frame. Like the first embodiment, FIG. 10 shows two-frame drive sequence consisting of a left frame displaying a white image and a right frame displaying a black image.

The first write for writing the rough image data is based on the original data which is interlaced data for tow-row simultaneous drive. In order to write the rough image at a higher speed, four-row simultaneous drive is used. As shown in the left frame of the image signal voltage 115 (Vdata), by using the data of the first two rows of the four rows simultaneously written, write is performed with the positive polarity. The first write is followed by the second write which uses both of the image data of the first two rows and the image data of the second two rows. Among the second write performed three times, the first time write is the negative polarity write using the image data of the second two rows, the third time write is the positive polarity write using the image data of the second two rows, and the second time write is the negative polarity write using the image data of the first two rows. Here, the hatched portions of the image signal voltage 115 (Vdata) indicate write polarity in an arbitrary column wiring.

In this embodiment, it is possible to use 4 row simultaneous selection even if the write speed is under the write load condition identical to the conventional condition. Accordingly, it is possible to obtain a high-speed write higher by four times. Thus, as shown in FIG. 10, the first write of the rough image write can be reduced to ⅛ frame. Furthermore, the second write also terminates in ⅛ frame. Accordingly, it is possible to assure a sufficient response time until the light source lighting. Furthermore, among the second write, the write performed twice at the latter half for reaching in-frame AC writes the same image data as the first and the second write at the first half. Accordingly, there is no danger of generation of flicker or burn-in image.

In the next right frame, according to an almost identical sequence, the image signal voltage 115 is written. In order to improve resolution, by detecting a difference between the odd-number row image data and the even-number row image data of the interlaced image data, the upper/lower relationship with the preceding frame is judged and one-row shift is performed upward or downward when write is started. This enables reproduction of the resolution of the interlaced image.

As has been described above, according to the present embodiment, it is possible to realize a high-speed image data write using the interlaced image data characteristic. Accordingly, there is almost no time difference between the upper and lower portions of the screen, thereby realizing a moving picture display having no periodically switching ghost or burn-in image. Furthermore, by performing image write by distinguishing the even-number rows and the odd-number rows of the interlaced image for each frame, it is possible to realize a moving picture display with a high resolution.

(Embodiment 4)

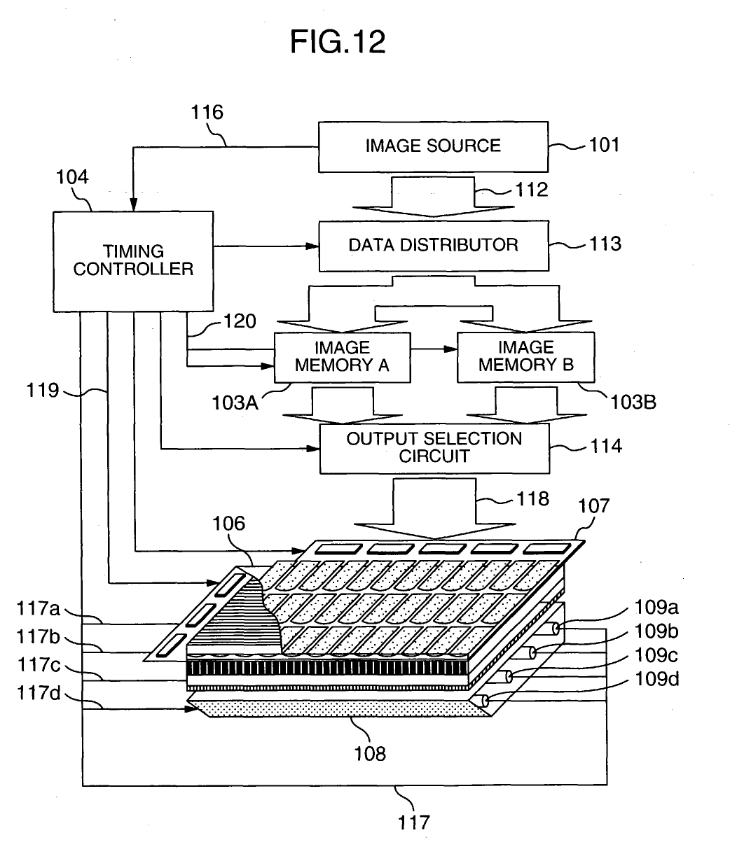

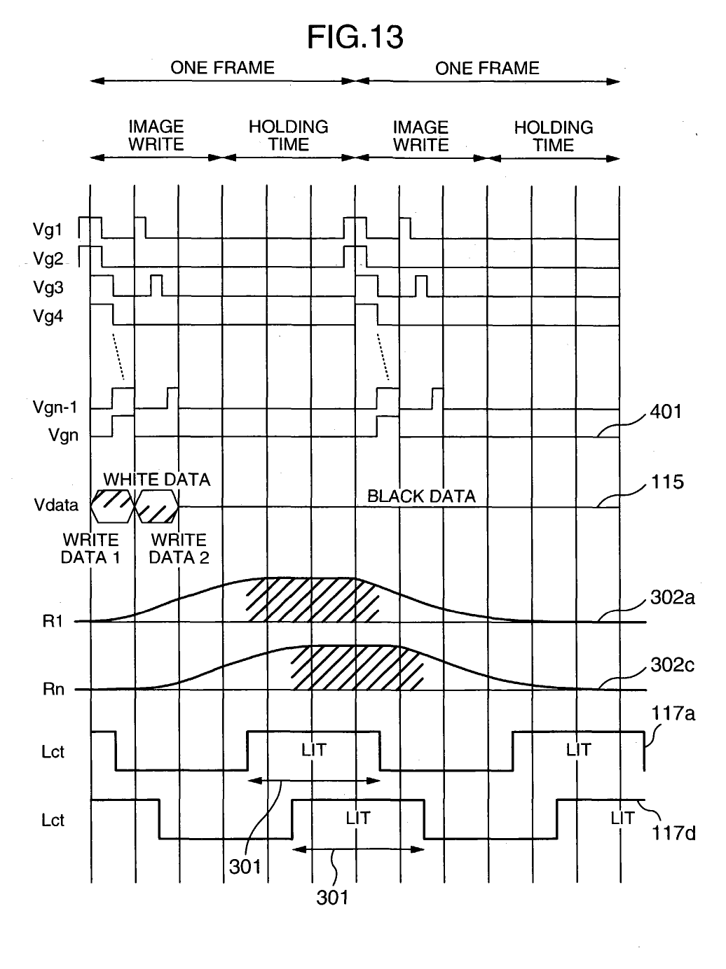

Description will now be directed to a fourth embodiment of the present invention with reference to FIG. 12 and FIG. 13.

The present embodiment provides a liquid crystal display device for visualizing an image by periodically switching an light source which completely prevents brightness inclination and periodically switching ghost caused by liquid crystal optical response and significantly improves the visibility of the moving picture.

FIG. 12 shows an example of system configuration of the liquid crystal display device according to the present embodiment. The present embodiment is identical to the first embodiment except for the configuration and control of the light source. The light source 108 of the present embodiment includes a plurality of light source blocks 109a to 109d arranged immediately below the liquid crystal display unit. The light source blocks 109a to 109d are controlled to light by light source control signals 117a to 117d so as to scroll from the uppermost row to the lowermost low of the liquid crystal display screen. That is, the lit area moves according to the area where the liquid crystal sufficiently responds. The method of moving the lit area of the light source on the light source block basis is also disclosed in the conventional configuration. However, as the number of light source blocks decreases, there has been a case that a block-shaped display defect is recognized. This problem is solved by the present embodiment. In FIG. 12, the light source block is depicted as a single lamp but the number of lamps constituting the light source block is not limited to one. The light source block may be any type if a block-shaped or a belt-shaped light source can move. The light source is not limited to a line-shaped light source but may be a light source block in which point-shaped light sources such as LED are arranged in an array or a light source block in which an optical guide is controlled by an optical switch so as to move the light source block. FIG. 13 shows a drive sequence in the present embodiment. In this embodiment, a case of white display over the entire screen for each frame is considered. Firstly, explanation will be given on the drive sequence of the display method in the present embodiment.

The gate driver output voltages Vg1 to Vgn and the image signal voltage 115 (Vdata) are identical to those of the first embodiment. The present embodiment is characterized in that a time difference is provided in synchronization with the voltage write to the pixels by the image data at lighting timing of light source blocks 109a to 109d by the light source control signals 117a to 117d (here, 117b and 117c are omitted). By providing this time difference, it is possible to realize display of excellent moving picture performance having no brightness inclination over the liquid crystal display screen as shown in the transmittance characteristic considering the lighting state of the light source shown by the hatched portion in the pixel transmittance 302a and 302d of the uppermost row and the lowermost row. As for the block-state display defect as a problem when the light source is lit by scrolling, by the high-speed write by the rough image write of the present embodiment, the write speed increase coefficient q=8. Even when the light source blocks are arranged only at the top and the bottom (p=2), p×q=16. Thus, it is possible to obtain an effect to eliminate the block-shaped display defect equivalent to the effect obtained when performing 16-block division.

In this embodiment, the image data write period is divided into a first write for writing a rough image by the write data 1 on the all the pixels and a second write for rewriting at least some pixels by write data 2 to realize a detailed image display, thereby increasing the response speed by the rough image write. Image data is written for a period shorter than one frame and the light source block is scrolled to be lit at the timing when the liquid crystal responds to a certain extent in synchronization with the write sequence. Thus, it is possible to obtain a desired effect. A significant effect can be obtained by performing high-speed write by dividing the write into the first write and the second write. However, it is not necessarily required to divide the write into the first and the second write. It is also possible to obtain a sufficient effect by a high-speed write of image data using an active element made of a low-temperature poly-Si and arranging a high-speed drive circuit in the periphery of the liquid crystal display unit.

According to the present embodiment using the scroll light source in combination with the high-speed image write, it is possible to obtain an effect to eliminate block-shaped display defect equivalent to a plenty of block light sources, thereby obtaining liquid crystal display device having little block-shaped display defect or blur.

(Embodiment 5)

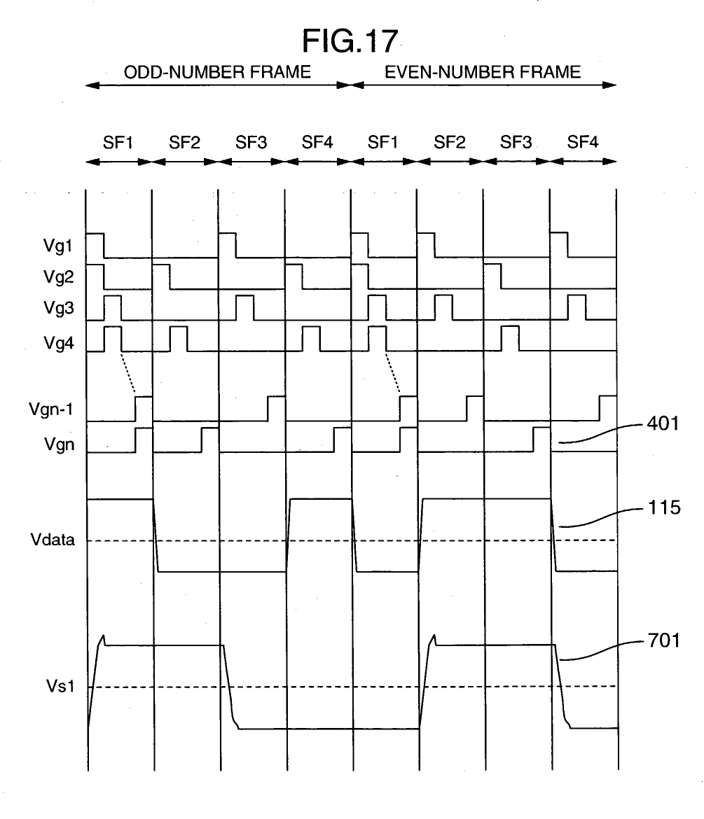

Description will now be directed to a fifth embodiment with reference to FIG. 17.

The present embodiment provides liquid crystal display device for visualizing an image by periodically switching a light source, which device uses a drive method capable of suppressing periodically switching ghost by reducing the write duty and preventing application of DC voltage to the liquid crystal when displaying a moving picture. In general, in the liquid crystal display device drive method, polarity of voltage applied to the liquid crystal is reversed for at least each frame. In the case of a still image, the voltage applied to a frame is identical to the voltage applied to the next frame but the polarity is reversed. Accordingly, alternation of the liquid crystal drive voltage is complete in two frames and the effective DC component becomes 0. However, in the case of a moving picture, a voltage applied to a certain frame is different from a voltage applied to the next frame. Accordingly, even if the polarity is reversed, alternation is not complete and a DC component remains. It is known that when a DC voltage is applied to the liquid crystal, the characteristic is deteriorated. Even when a moving picture is displayed, it is preferable that no DC voltage be applied to the liquid crystal.

FIG. 17 shows a drive sequence of the drive method used in the present embodiment. In this figure, a gate potential, a drain potential, a common potential, and a pixel electrode potential 701 of the first row when attention is paid on a certain odd-number row are shown for two frames. In the drive method used in this embodiment, one frame is divided to four sub-fields SF1, SF2, SF3, and SF4.

Firstly, explanation will be given on the odd-number frame. In the first sub-field SF1, two rows are made into a pair and two-row simultaneous selection scan is performed by simultaneously writing two rows with the positive polarity using the image data of the odd-number rows as precharge data. In the second sub-field SF2, an even-number row selection scan is performed by using the image data of even-number rows as overwrite data and writing it into the pixels of the corresponding even-number rows with the negative polarity. In the third sub-field SF3, an odd-number row selection scan is performed by using the image data of odd-number rows as overwrite data and writing it into the corresponding odd-number rows with the negative polarity. In the fourth sub-field SF4, an even-number row selection scan is performed by using the image data of even-number rows as overwrite data and writing it into the even-number rows with the positive polarity.

Next, explanation will be given on the even-number frame. In the first sub-field SF1, two rows are made into a pair and two-row simultaneous selection scan is performed by simultaneously writing two rows with the negative polarity using the image data of the even-number rows as precharge data. In the second sub-field SF2, an odd-number row selection scan is performed by using the image data of odd-number rows as overwrite data and writing it into the pixels of the corresponding odd-number rows with the positive polarity. In the third sub-field SF3, an even-number row selection scan is performed by using the image data of even-number rows as overwrite data and writing it into the corresponding even-number rows with the positive polarity. In the fourth sub-field SF4, an odd-number row selection scan is performed by using the image data of odd-number rows as overwrite data and writing it into the odd-number rows with the negative polarity. As for the even-number columns, the same as the aforementioned is performed by reversing the polarity.

Here, the polarity of voltage applied to the liquid crystal is considered. When the aforementioned drive method is used, the pixel electrode potential 701 of the pixels of the first row will be as shown in FIG. 17. Firstly, in the odd-number frame, the pixel electrode potential 701 of the pixels of the first row has positive polarity in the first field and in the second field, and negative polarity in the third field and the fourth field. The positive polarity potential of the first and the second field is the image data of the first row written in the first field and the negative polarity potential of the third field and the fourth field is the image data of the first row written in the third field. That is, in the first row liquid crystal, in the odd-number frame, voltage of an identical value has reversed polarity in the second half compared to the first half of the frame, thereby completing alternation in one frame. In the even-number frame, the pixel electrode potential 701 of the pixels of the first row has negative polarity in the first field, positive polarity in the second field and the third field, and negative polarity in the fourth field. The negative polarity potential of the first field is the image data of the second row written in the first row. The positive polarity potential of the second and the third field is the image data of the first row written in the second field. The negative polarity potential of the fourth field is the image data of the first row written in the fourth field. That is, to the first row liquid crystal, voltage of negative polarity is applied in the first field and the fourth field, and voltage of positive polarity is applied in the second field and the third field. Accordingly, when the image data of the first row is identical to the image data of the second row, alternation is complete within one frame. When the image data of the first row is different from that of the second row, DC voltage is applied. However, in case of an interlaced signal such as a television signal, the difference is often small and the alternation is complete in the odd-number frame without fail.

Accordingly, DC voltage is hardly applied to the liquid crystal. As has been described above, according to this drive method, since the write duty is 1/4 in the first sub-field, the time difference between the top and bottom of the screen when the liquid crystal starts response is small. Accordingly, it is possible to suppress the periodically switching ghost and significantly reduce the application of DC voltage to the liquid crystal even when a moving picture is displayed.

These embodiments have following effects.

Precharge data write for high-speed rough image data write and subsequent overwrite data write are performed so as to display a detailed image and the periodical switching of a light source is used in combination, thereby preventing periodical switching ghost in the moving picture display. Thus, it is possible to provide a liquid crystal display apparatus having an excellent moving picture display performance.

Furthermore, in combination of the interlaced drive widely used in the moving picture display with a liquid crystal display device illuminated by a periodically switching light source, by combining one-frame periodical flow drive with four-row simultaneous drive, it is possible to provide a liquid crystal display device not generating flicker regardless of the type of the moving picture.

By using the scroll light source in combination with the high-speed image write, it is possible to obtain an effect equivalent to a plenty of block light sources to eliminate block-shaped display defect. Thus, it is possible to provide a liquid crystal display device capable of displaying a moving picture having little block-shaped display defect or blur.

According to the present invention, it is possible to provide a liquid crystal display device having an excellent moving picture display performance capable of suppressing the vertical brightness inclination and generation of periodically switching ghost in the moving picture display.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A liquid crystal display device comprising a periodically switching light source repeatedly turning ON and OFF at a predetermined timing and a display unit for displaying an image by controlling light transmission or reflection of the periodically switching light source according to the image data,
wherein write into the liquid crystal display device in each display frame constituting an image is divided into a first write for writing into all the pixels using precharge data as representative of a plurality of pixels created according to a first algorithm and a second write for additionally writing overwriting data created on at least some pixels according to a second algorithm, thereby displaying an image.

2. A liquid crystal display device as claimed in claim 1, wherein the display unit includes a liquid crystal layer sandwiched by two substrates at least one of which is transparent, a plurality of row wires and a plurality of column wires on one of the two substrates, and active elements on the intersections between the row wires and the column wires, so that image data is written by dot sequentially or line sequentially via the active elements into the pixels arranged in a matrix.

3. A liquid crystal display apparatus as claimed in claim 2, wherein precharge data used for the first write is composed of image data representative of image data of a plurality of desired rows and an image composed of the desired rows is written by the precharge data.

4. A liquid crystal display device as claimed in claim 3, wherein the precharge data is composed of image data extracted by every other j rows from predetermined rows.

5. A liquid crystal display device as claimed in claim 3, wherein the precharge data is composed of a column-direction average value of image data consisting of j rows in the vicinity.

6. A liquid crystal display device as claimed in claim 3, wherein the precharge data consists of data of the slowest response time in the data change from the preceding frame among the j data pieces of the same column in the image data of j rows in the vicinity.

7. A liquid crystal display device as claimed in claim 1, wherein the liquid crystal display unit writes image data dot sequentially or line sequentially into the pixels arranged in a matrix state via the active elements, thereby maintaining and displaying the image for a certain period, the periodically switching light source periodically turns ON and OFF in synchronization with the display timing of the liquid crystal display unit, and during the first write, a plurality of rows are simultaneously selected so that image data of one of the rows is written and during the second write, the remaining image data is successively written at once or divided into a plurality of sub-fields on row basis for writing.

8. A liquid crystal display device as claimed in claim 7, wherein in the second writing, the remaining image data is divided into a plurality of sub-fields for writing and write polarity is reversed for each row.

9. A liquid crystal display device as claimed in claim 8, in the latter half of the display frame, by using the image data used in the first half of the frame, third write and fourth write are added with reversed polarity.

10. A liquid crystal display device comprising a liquid crystal display unit having a liquid crystal layer sandwiched by two substrates at least one of which is transparent, a plurality of row wires and a plurality of column wires on one of the two substrates, and active elements on the intersections between the row wires and the column wires, so that image data is maintained for a certain time and written by dot sequentially or line sequentially via the active elements into the pixels arranged in a matrix, and a periodically switching light source periodically turning ON and OFF in synchronization with the display timing of the liquid crystal display unit,
wherein interlaced image data is input, each image data is assigned to a pair of rows, the start row is alternately changed in the odd-number field and the even-number field, in each display field constituting one image, write to the liquid crystal display unit is divided for display into a first write for high-speed writing of all the pixels during an OFF period of the periodically switching light source by using the precharge data capable of rough image display and a second write for additionally writing interpolation data to at least some of the pixels which have performed the first write, thereby displaying detailed image data, and by using the image data used in the first half of the field, a third write and a fourth write are added with reversed polarity.

11. A liquid crystal display device as claimed in claim 10, wherein during the first write, two pairs of rows are simultaneously selected and image data of one of the pairs of rows is written and during the second write, one pair of rows is simultaneously selected and interlaced scan on two-pair basis is performed to write the remaining image data, and in the latter half of the display field, the image data used in the first half of the field is used so that a third write and a fourth write are added with reversed polarity.

12. A liquid crystal display device as claimed in claim 9, wherein the write polarity in one sub-field is made identical and a selection period of an arbitrary row is overlapped with the selection period of the next row selected.

13. A liquid crystal display device as claimed in claim 12, wherein the periodically switching light source is lit at a desired timing after the second write is complete.

14. A liquid crystal display device comprising a liquid crystal display unit having a liquid crystal layer sandwiched by two substrates at least one of which is transparent, a plurality of row wires and a plurality of column wires on one of the two substrates, and active elements on the intersections between the row wires and the column wires, so that image data is maintained for a certain time and written by dot sequentially or line sequentially via the active elements into the pixels arranged in a matrix, and a periodically switching light source periodically turning ON and OFF in synchronization with the display timing of the liquid crystal display unit,
wherein the periodically switching light source consists of a plurality of light source blocks whose lighting timings can respectively be controlled in synchronization with the display timing of the liquid crystal display unit,
the liquid crystal display device further comprising a high-speed writing circuit for increasing the speed of the writing input image data from an external image source higher than the acquisition speed and writing it in the liquid crystal display unit.

15. A liquid crystal display device as claimed in claim 14, wherein a number p of the light source blocks and a ratio q of the image acquisition speed with respect to the write speed are both greater than 1.

16. A liquid crystal display device as claimed in claim 15, wherein a product p×q of the number p of the light source blocks and the ratio q of the image acquisition speed with respect to the write speed is greater than 3.

17. A liquid crystal display device as claimed in claim 14, wherein the high-speed writing circuit for increasing the speed higher than the acquisition speed when writing into the liquid crystal display unit is a circuit for dividing in each display field constituting one image, write to the liquid crystal display unit into a first write for high-speed writing of all the pixels during an OFF period of the periodically switching light source by using the precharge data capable of rough image display and a second write for additionally writing detailed image data to at least some of the pixels which have performed the first write.
